(19) United States
(12) Patent Application Publication
(10) Pub. No.: US 2024/0071681 A1
(43) Pub. Date: Feb. 29, 2024

(54) INDUCTOR COMPONENT

(71) Applicant: Murata Manufacturing Co., Ltd., Kyoto-fu (JP)

(72) Inventor: Kiyotaka NISHI, Nagaokakyo-shi (JP)

(73) Assignee: Murata Manufacturing Co., Ltd., Kyoto-fu (JP)

(21) Appl. No.: 18/455,536

(22) Filed: Aug. 24, 2023

(30) Foreign Application Priority Data
Aug. 26, 2022 (JP) 2022-134969

(51) Int. Cl. H01F 27/28; H01F 17/00; H01F 27/29

(52) U.S. Cl. CPC H01F 27/2823; H01F 17/0013; H01F 27/292; H01F 27/323

(57) ABSTRACT

An inductor component including an element body and an inductor wiring having a lower side portion including a portion closest to a bottom surface of an element body and extending along the bottom surface. In the element body, a range from a first virtual plane to a second virtual plane is defined as a wiring range. A first protrusion portion of a first electrode protrudes from an end of a first bottom surface electrode portion of the first electrode on a second end surface side toward the second end surface side. A maximum dimension of the first protrusion portion in a direction perpendicular to a first main surface is smaller than a maximum dimension of the first bottom surface electrode portion in the direction perpendicular to the first main surface. At least a part of the first protrusion portion on the bottom surface is located within the wiring range.

### CROSS-REFERENCE TO RELATED APPLICATION

This application claims benefit of priority to Japanese Patent Application No. 2022-134969, filed Aug. 26, 2022, the entire content of which is incorporated herein by reference.

### BACKGROUND

### Technical Field

The present disclosure relates to an inductor component.

### Background Art

The inductor component described in Japanese Patent Application Laid-Open No. 2018-200966 includes an element body having a rectangular parallelepiped shape having six outer surfaces. The six outer surfaces of the element body are a first main surface that is a surface having the largest area, a second main surface parallel to the first main surface, a first end surface perpendicular to the first main surface, a second end surface parallel to the first end surface, a bottom surface perpendicular to the first main surface and the first end surface, and a top surface parallel to the bottom surface. In addition, the inductor component includes an inductor wiring wound in a spiral shape. The inductor wiring is located inside the element body. The element body includes a first electrode and a second electrode. A first end of the inductor wiring is connected to the first electrode. A second end of the inductor wiring is connected to the second electrode. The first electrode is exposed to the outside of the element body in a region from the first end surface to the bottom surface. The second electrode is exposed to the outside of the element body in a region from the second end surface to the bottom surface.

In addition, when the inductor component described in Japanese Patent Application Laid-Open No. 2018-200966 is viewed in the direction perpendicular to the first main surface, the inductor wiring has a circling path that circles. The inductor wiring includes a portion closest to the bottom surface and has a lower side portion extending in parallel to the bottom surface. The first electrode and the second electrode are located within a range where the lower side portion is not present in a direction perpendicular to the first end surface.

### SUMMARY

In the inductor component as described in Japanese Patent Application Laid-Open No. 2018-200966, from the viewpoint of reducing the stray capacitance generated between the lower side portion of the inductor wiring and each electrode, each electrode and the lower side portion are preferably separated from each other in the direction perpendicular to the first end surface. On the other hand, in the inductor component as described in Japanese Patent Application Laid-Open No. 2018-200966, the first electrode and the second electrode are fixed to a land electrode such as a substrate via a covering electrode which is plating, a mounting solder, or the like. At this time, the larger the area of each electrode exposed to the bottom surface of the element body is, the stronger the electrode can be fixed to the substrate or the like. Therefore, if the area of each electrode is reduced in order to increase the distance to the lower side portion, the fixing force of the inductor component to the substrate or the like may be insufficient.

Accordingly, the present disclosure provides an inductor component including an element body having a rectangular parallelepiped shape having six outer surfaces; and an inductor wiring extending inside the element body. The element body includes a first electrode connected to a first end of the inductor wiring and a second electrode connected to a second end of the inductor wiring. When a specific one surface of six outer surfaces of the element body is defined as a main surface, one of surfaces perpendicular to the main surface is defined as a first end surface, a surface parallel to the first end surface is defined as a second end surface, and one of surfaces perpendicular to both the main surface and the first end surface is defined as a bottom surface. The inductor wiring includes a lower side portion including a portion closest to the bottom surface and extending along the bottom surface. When a virtual plane including an end of the lower side portion on the first end surface side and parallel to the first end surface is defined as a first virtual plane, a virtual plane including an end of the lower side portion on the second end surface side and parallel to the first end surface is defined as a second virtual plane, and a range from the first virtual plane to the second virtual plane in the element body is defined as a wiring range. The first electrode has a bottom surface electrode portion exposed to an outside of the element body on the bottom surface and a protrusion portion exposed to the outside of the element body on the bottom surface. The bottom surface electrode portion is located only within a range from the first end surface to an end on the first end surface side in the wiring range. The protrusion portion protrudes from an end of the bottom surface electrode portion on the second end surface side toward the second end surface side. A maximum dimension of the protrusion portion in a direction perpendicular to the main surface is smaller than a maximum dimension of the bottom surface electrode portion in the direction perpendicular to the main surface, and at least a part of the protrusion portion on the bottom surface is located within the wiring range.

According to the above configuration, the area where the first electrode is exposed on the bottom surface can be secured by the presence of the protrusion portion. Although the protrusion portion is located within the wiring range, the maximum dimension of the protrusion portion in the direction perpendicular to the main surface is smaller than the maximum dimension of the bottom surface electrode portion in the same direction. Therefore, the stray capacitance generated between the first electrode and the inductor wiring can be reduced as compared with the case where the bottom surface electrode portion itself is located within the wiring range.

The area where the first electrode is exposed on the bottom surface can be secured while suppressing an excessive increase in stray capacitance generated between the first electrode and the inductor wiring.

### BRIEF DESCRIPTION OF THE DRAWINGS

FIG. 1 is a perspective view of an inductor component of an embodiment;

FIG. 2 is an exploded perspective view of the inductor component of the embodiment;

FIG. 3 is a plan view of a first layer in the inductor component of the embodiment;

FIG. 4 is a bottom view of an element body of the embodiment;

FIG. 5 is a bottom view of an element body of a modification;

FIG. 6 is a bottom view of an element body of a modification;

FIG. 7 is a bottom view of an element body of a modification;

FIG. 8 is a bottom view of an element body of a modification;

FIG. 9 is a bottom view of an element body of a modification; and

FIG. 10 is a bottom view of an element body of a modification.

### DETAILED DESCRIPTION

### Embodiment

In the following, an embodiment of an inductor component will be described. The drawings may show enlarged components to facilitate understanding. The dimensional ratios of the components may be different from the actual ones or those in another drawing.

<Overall Configuration>

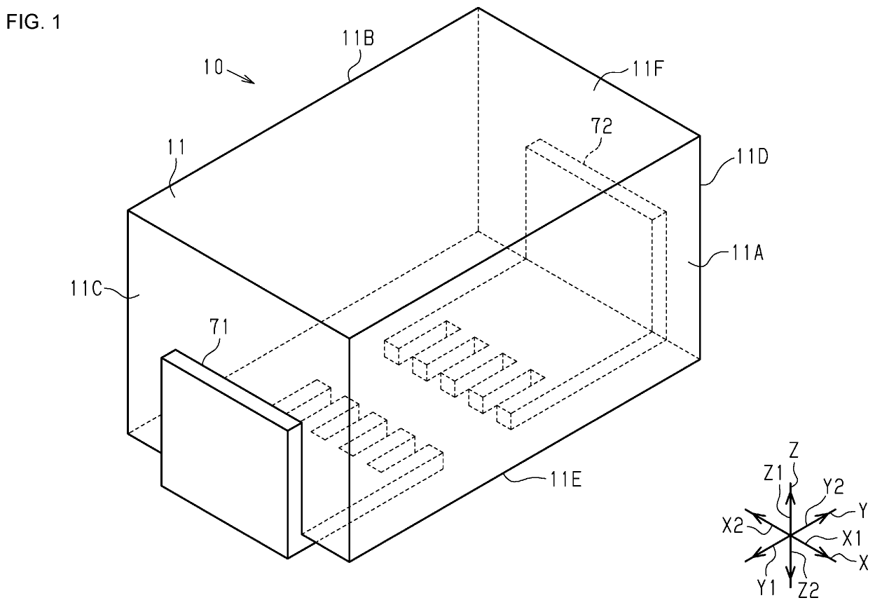

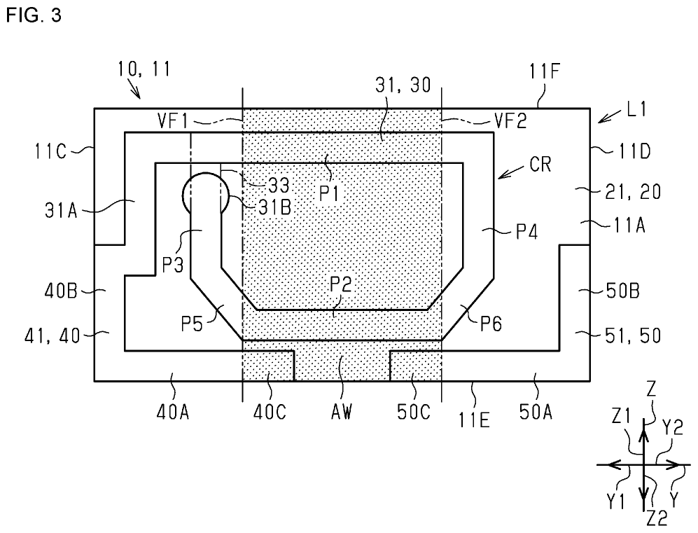

As illustrated in FIG. 1, an inductor component 10 includes an element body 11 having a rectangular parallelepiped shape. As illustrated in FIG. 3, the inductor component 10 includes an inductor wiring 30 extending inside the element body 11. The element body 11 includes a first electrode 40 connected to a first end of the inductor wiring 30 and a second electrode 50 connected to a second end of the inductor wiring 30.

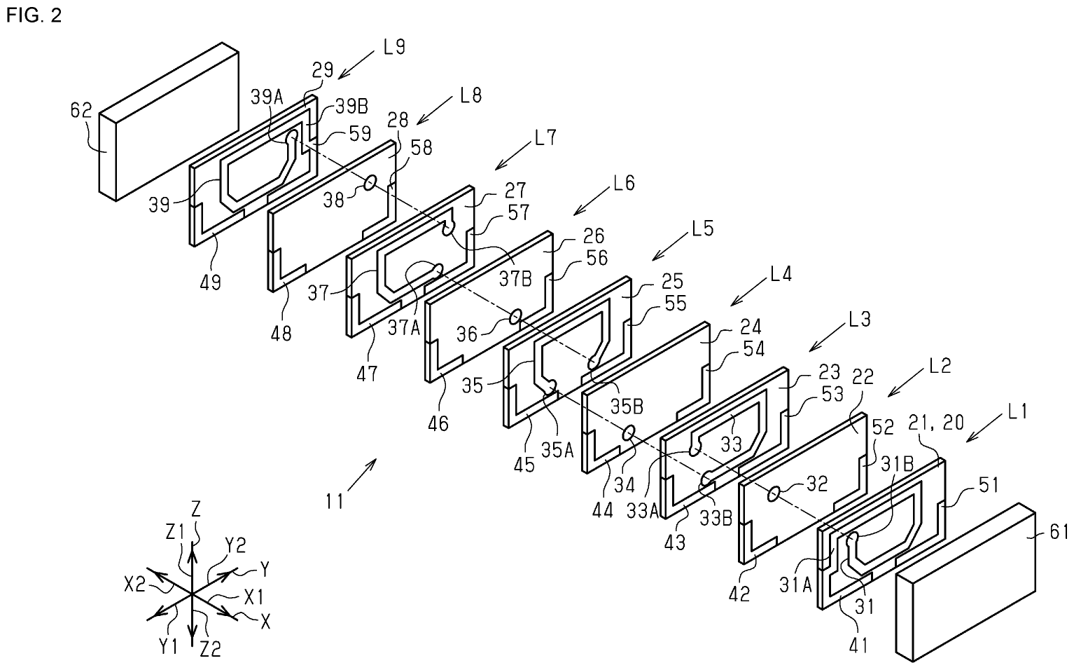

As illustrated in FIG. 2, the element body 11 has a structure in which a plurality of plate-shaped layers are laminated as a whole. Each layer has a rectangular shape in plan view. Since the element body 11 has a rectangular parallelepiped shape, it has six outer surfaces. As illustrated in FIG. 1, among these six outer surfaces, one specific surface parallel to the main surface of each layer is defined as a first main surface 11A. A surface parallel to the first main surface 11A is defined as a second main surface 11B. One specific surface perpendicular to the first main surface 11A is defined as a first end surface 11C. A surface parallel to the first end surface 11C is defined as a second end surface 11D. Further, one specific surface perpendicular to both the first main surface 11A and the first end surface 11C is defined as a bottom surface 11E. A surface parallel to the bottom surface 11E is defined as a top surface 11F.

In the following description, an axis along a direction in which a plurality of layers are laminated, that is, an axis perpendicular to the first main surface 11A is defined as a first axis X. An axis perpendicular to the first end surface 11C is defined as a second axis Y. Further, an axis perpendicular to the bottom surface 11E is defined as a third axis Z. Of the directions along the first axis X, a direction in which the first main surface 11A faces is defined as a first positive direction X1, and a direction opposite to the first positive direction X1 is defined as a first negative direction X2. Of the directions along the second axis Y, a direction in which the first end surface 11C faces is defined as a second positive direction Y1, and a direction opposite to the second positive direction Y1 is defined as a second negative direction Y2. Furthermore, of the directions along the third axis Z, a direction in which the top surface 11F faces is defined as a third positive direction Z1, and a direction opposite to the third positive direction Z1 is defined as a third negative direction Z2.

As illustrated in FIG. 2, the element body 11 includes a first layer L1 to a ninth layer L9. The first layer L1 to the ninth layer L9 are arranged in this order in the first negative direction X2. The thicknesses of the first layer L1 to the ninth layer L9, that is, the dimensions in the direction along the X axis are all substantially the same. As illustrated in FIG. 3, the first layer L1 includes a first electrode portion 41, a second electrode portion 51, a first wiring portion 31, and a first insulating portion 21.

The first electrode portion 41 is made of a conductive material such as silver. When the first layer L1 is viewed in the first negative direction X2, the first electrode portion 41 has an L shape as a whole. When the first layer L1 is viewed in the first negative direction X2, the first electrode portion 41 is located on the second positive direction Y1 side and the third negative direction Z2 side with respect to the center of the first layer L1. More specifically, when the first layer L1 is viewed in the first negative direction X2, the first electrode portion 41 is located at a position including a corner on the second positive direction Y1 side and the third negative direction Z2 side of the first layer L1.

The maximum dimension of the first electrode portion 41 in the direction along the third axis Z is approximately ½ times or more the dimension of the first layer L1 in the direction along the third axis Z. The maximum dimension of the first electrode portion 41 in the direction along the third axis Z is a dimension of a portion of the first electrode portion 41 extending along the first end surface 11C in the direction along the third axis Z. That is, the end of the first electrode portion 41 on the third positive direction Z1 side is located on the third positive direction Z1 side from the center of the first layer L1 in the direction along the third axis Z. The maximum dimension of the first electrode portion 41 in the direction along the second axis Y is smaller than ½ times the dimension of the first layer L1 in the direction along the second axis Y. The maximum dimension of the first electrode portion 41 in the direction along the second axis Y is ¼ times or more the dimension of the first layer L1 in the direction along the second axis Y. The maximum dimension of the first electrode portion 41 in the direction along the second axis Y is a dimension of a portion of the first electrode portion 41 extending along the bottom surface 11E in the direction along the second axis Y. That is, the end of the first electrode portion 41 on the second negative direction Y2 side is located on the second positive direction Y1 side from the center of the first layer L1 in the direction along the second axis Y.

The second electrode portion 51 is made of a conductive material such as silver. When the first layer L1 is viewed in the first negative direction X2, the second electrode portion 51 has an L shape as a whole. When the first layer L1 is viewed in the first negative direction X2, the second electrode portion 51 is located on the second negative direction Y2 side and the third negative direction Z2 side with respect to the center of the first layer L1. More specifically, when the first layer L1 is viewed in the first negative direction X2, the second electrode portion 51 is located at a position including a corner on the second negative direction Y2 side and the third negative direction Z2 side of the first layer L1.

The maximum dimension of the second electrode portion 51 in the direction along the third axis Z is approximately ½ times or more the dimension of the first layer L1 in the direction along the third axis Z. The maximum dimension of the second electrode portion 51 in the direction along the third axis Z is a dimension of a portion of the second electrode portion 51 extending along the second end surface 11D in the direction along the third axis Z. That is, the end of the second electrode portion 51 on the third positive direction Z1 side is located on the third positive direction Z1 side from the center of the first layer L1 in the direction along the third axis Z. The maximum dimension of the second electrode portion 51 in the direction along the second axis Y is smaller than ½ times the dimension of the first layer L1 in the direction along the second axis Y. The maximum dimension of the second electrode portion 51 in the direction along the second axis Y is ¼ times or more the dimension of the first layer L1 in the direction along the second axis Y. The maximum dimension of the second electrode portion 51 in the direction along the second axis Y is a dimension of a portion of the second electrode portion 51 extending along the bottom surface 11E in the direction along the second axis Y. That is, the end of the second electrode portion 51 on the second positive direction Y1 side is located on the second negative direction Y2 side from the center of the first layer L1 in the direction along the second axis Y.

The first wiring portion 31 is made of a conductive material such as silver. When the first layer L1 is viewed in the first negative direction X2, the first wiring portion 31 extends as a whole in a spiral shape with the center of the first layer L1 as a substantial center. Specifically, a first end portion 31A of the first wiring portion 31 is connected to an end portion of the first electrode portion 41 on the third positive direction Z1 side in the direction along the third axis Z. The first end portion 31A is a portion deviated from the circling path CR configured by overlapping the wiring portions of the first layer L1 to the ninth layer L9 when viewed in the first negative direction X2. The circling path CR will be described later. That is, the first end portion 31A is a first end of the inductor wiring 30. The wiring width of the first wiring portion 31 is substantially constant except for a second end portion 31B. The position of the second end portion 31B of the first wiring portion 31 in the direction along the third axis Z is on the third positive direction Z1 side from the center in the direction along the third axis Z. The position of the second end portion 31B of the first wiring portion 31 in the direction along the second axis Y is on the second positive direction Y1 side from the center in the direction along the second axis Y. When the first wiring portion 31 is viewed in the first negative direction X2, the first wiring portion 31 extends clockwise from the first end portion 31A toward the second end portion 31B.

The second end portion 31B of the first wiring portion 31 functions as a pad for connection with a via 32 to be described later. When the first layer L1 is viewed in the first negative direction X2, the second end portion 31B has a substantially circular shape. The second end portion 31B of the first wiring portion 31 has a wiring width larger than that of the other portion of the first wiring portion 31.

In the first layer L1, a portion excluding the first electrode portion 41, the second electrode portion 51, and the first wiring portion 31 is the first insulating portion 21. The first insulating portion 21 is made of a nonmagnetic insulator such as glass, resin, or alumina.

As illustrated in FIG. 2, the second layer L2 is laminated on the main surface of the first layer L1 facing the first negative direction X2. When the second layer L2 is viewed in the first negative direction X2, the second layer L2 has the same rectangular shape as the first layer L1. The second layer L2 includes a third electrode portion 42, a fourth electrode portion 52, the via 32, and a second insulating portion 22.

The third electrode portion 42 is made of the same material as the first electrode portion 41. When the second layer L2 is viewed in the first negative direction X2, the third electrode portion 42 has an L shape as a whole. When the second layer L2 is viewed in the first negative direction X2, the third electrode portion 42 is located on the second positive direction Y1 side and the third negative direction Z2 side with respect to the center of the second layer L2. More specifically, when the second layer L2 is viewed in the first negative direction X2, the third electrode portion 42 is located at a position including a corner on the second positive direction Y1 side and the third negative direction Z2 side of the second layer L2. Therefore, the third electrode portion 42 is laminated on the surface of the first electrode portion 41 facing the first negative direction X2.

The maximum dimension of the third electrode portion 42 in the direction along the third axis Z is equal to the dimension of the first electrode portion 41 in the direction along the third axis Z. The maximum dimension of the third electrode portion 42 in the direction along the second axis Y is smaller than the maximum dimension of the first electrode portion 41 in the direction along the second axis Y. The maximum dimension of the third electrode portion 42 in the direction along the second axis Y is a dimension of a portion extending along the bottom surface 11E in the direction along the second axis Y.

The fourth electrode portion 52 is made of the same material as the second electrode portion 51. The fourth electrode portion 52 has an L shape as a whole when the second layer L2 is viewed in the first negative direction X2. When the second layer L2 is viewed in the first negative direction X2, the fourth electrode portion 52 is located on the second negative direction Y2 side and the third negative direction Z2 side with respect to the center of the second layer L2. More specifically, when the second layer L2 is viewed in the first negative direction X2, the fourth electrode portion 52 is located at a position including a corner on the second negative direction Y2 side and the third negative direction Z2 side of the second layer L2. Therefore, the fourth electrode portion 52 is laminated on the surface of the second electrode portion 51 facing the first negative direction X2.

The maximum dimension of the fourth electrode portion 52 in the direction along the third axis Z is equal to the dimension of the second electrode portion 51 in the direction along the third axis Z. The maximum dimension of the fourth electrode portion 52 in the direction along the second axis Y is smaller than the maximum dimension of the second electrode portion 51 in the direction along the second axis Y. The maximum dimension of the fourth electrode portion 52 in the direction along the second axis Y is a dimension of a portion extending along the bottom surface 11E in the direction along the second axis Y.

The via 32 is made of the same material as the first wiring portion 31. The via 32 has a columnar shape extending in the direction along the first axis X. The via 32 is laminated on a surface of the second end portion 31B of the first wiring portion 31 facing the first negative direction X2. Therefore, the via 32 is electrically connected to the second end portion 31B of the first wiring portion 31. The via 32 extends from the second end portion 31B of the first wiring portion 31 in the first negative direction X2.

In the second layer L2, a portion excluding the third electrode portion 42, the fourth electrode portion 52, and the via 32 is the second insulating portion 22. The second insulating portion 22 is made of a nonmagnetic insulator of the same material as the first insulating portion 21.

The third layer L3 is laminated on the main surface of the second layer L2 facing the first negative direction X2. When the third layer L3 is viewed in the first negative direction X2, the third layer L3 has the same rectangular shape as the first layer L1. The third layer L3 includes a fifth electrode portion 43, a sixth electrode portion 53, a second wiring portion 33, and a third insulating portion 23.

The fifth electrode portion 43 is made of the same material as the first electrode portion 41. When the third layer L3 is viewed in the first negative direction X2, the fifth electrode portion 43 has an L shape having the same dimension as the first electrode portion 41 and is located at the same position as the first electrode portion 41. Therefore, the fifth electrode portion 43 is laminated on the surface of the third electrode portion 42 facing the first negative direction X2. Since the dimension of the fifth electrode portion 43 is the same as the dimension of the first electrode portion 41, the maximum dimension of the fifth electrode portion 43 in the direction along the second axis Y is larger than the maximum dimension of the third electrode portion 42 in the direction along the second axis Y.

The sixth electrode portion 53 is made of the same material as the second electrode portion 51. When the third layer L3 is viewed in the first negative direction X2, the sixth electrode portion 53 has an L shape having the same dimension as the second electrode portion 51 and is located at the same position as the second electrode portion 51. Therefore, the sixth electrode portion 53 is laminated on the surface of the fourth electrode portion 52 facing the first negative direction X2. Since the dimension of the sixth electrode portion 53 is the same as the dimension of the second electrode portion 51, the maximum dimension of the sixth electrode portion 53 in the direction along the second axis Y is larger than the maximum dimension of the fourth electrode portion 52 in the direction along the second axis Y.

The second wiring portion 33 is made of the same material as the first wiring portion 31. When the third layer L3 is viewed in the first negative direction X2, the second wiring portion 33 extends as a whole in a spiral shape with the center of the third layer L3 as a substantial center. Specifically, the position of a first end portion 33A of the second wiring portion 33 is on the surface of the via 32 facing the first negative direction X2. Therefore, the first end portion 33A of the second wiring portion 33 is connected to the via 32. The wiring width of the second wiring portion 33 is substantially constant except for the first end portion 33A and a second end portion 33B. The position of the second end portion 33B of the second wiring portion 33 in the direction along the third axis Z is on the third negative direction Z2 side from the center of the third layer L3 in the direction along the third axis Z. The position of the second end portion 33B of the second wiring portion 33 in the direction along the second axis Y is on the second positive direction Y1 side from the center of the third layer L3 in the direction along the second axis Y. The position of the second end portion 33B of the second wiring portion 33 in the direction along the second axis Y is on the center side in the direction along the second axis Y from the position of the second end portion 31B of the first wiring portion 31 in the direction along the second axis Y. When the second wiring portion 33 is viewed in the first negative direction X2, the second wiring portion 33 extends clockwise from the first end portion 33A toward the second end portion 33B.

In the third layer L3, a portion excluding the fifth electrode portion 43, the sixth electrode portion 53, and the second wiring portion 33 is the third insulating portion 23. The third insulating portion 23 is made of a nonmagnetic insulator of the same material as the first insulating portion 21.

The fourth layer L4 is laminated on the main surface of the third layer L3 facing the first negative direction X2. When the fourth layer L4 is viewed in the first negative direction X2, the fourth layer L4 has the same rectangular shape as the first layer L1. The fourth layer L4 includes a seventh electrode portion 44, an eighth electrode portion 54, a via 34, and a fourth insulating portion 24.

The seventh electrode portion 44 is made of the same material as the first electrode portion 41. When the fourth layer L4 is viewed in the first negative direction X2, the seventh electrode portion 44 has an L shape having the same dimension as the third electrode portion 42 and is located at the same position as the third electrode portion 42. Therefore, the seventh electrode portion 44 is laminated on the surface of the fifth electrode portion 43 facing the first negative direction X2. Since the dimension of the seventh electrode portion 44 is the same as the dimension of the third electrode portion 42, the maximum dimension of the seventh electrode portion 44 in the direction along the second axis Y is smaller than the maximum dimension of the fifth electrode portion 43 in the direction along the second axis Y.

The eighth electrode portion 54 is made of the same material as the second electrode portion 51. When the fourth layer L4 is viewed in the first negative direction X2, the eighth electrode portion 54 has an L shape having the same dimension as the fourth electrode portion 52 and is located at the same position as the fourth electrode portion 52. Therefore, the eighth electrode portion 54 is laminated on the surface of the sixth electrode portion 53 facing the first negative direction X2. Since the dimension of the eighth electrode portion 54 is the same as the dimension of the fourth electrode portion 52, the maximum dimension of the eighth electrode portion 54 in the direction along the second axis Y is smaller than the maximum dimension of the sixth electrode portion 53 in the direction along the second axis Y.

The via 34 is made of the same material as the first wiring portion 31. The via 34 has a columnar shape extending in the direction along the first axis X. The via 34 is laminated on a surface of the second end portion 33B of the second wiring portion 33 facing the first negative direction X2. Therefore, the via 34 is electrically connected to the second end portion 33B of the second wiring portion 33. The via 34 extends from the second end portion 33B of the second wiring portion 33 in the first negative direction X2.

In the fourth layer L4, a portion excluding the seventh electrode portion 44, the eighth electrode portion 54, and the via 34 is the fourth insulating portion 24. The fourth insulating portion 24 is made of a nonmagnetic insulator of the same material as the first insulating portion 21.

The fifth layer L5 is laminated on the main surface of the fourth layer L4 facing the first negative direction X2. When the fifth layer L5 is viewed in the first negative direction X2, the fifth layer L5 has the same rectangular shape as the first layer L1. The fifth layer L5 includes a ninth electrode portion 45, a tenth electrode portion 55, a third wiring portion 35, and a fifth insulating portion 25.

The ninth electrode portion 45 is made of the same material as the first electrode portion 41. When the fifth layer L5 is viewed in the first negative direction X2, the ninth electrode portion 45 has an L shape having the same dimension as the first electrode portion 41 and is located at the same position as the first electrode portion 41. Therefore, the ninth electrode portion 45 is laminated on the surface of the seventh electrode portion 44 facing the first negative direction X2. Since the dimension of the ninth electrode portion 45 is the same as the dimension of the first electrode portion 41, the maximum dimension of the ninth electrode portion 45 in the direction along the second axis Y is larger than the maximum dimension of the seventh electrode portion 44 in the direction along the second axis Y.

The tenth electrode portion 55 is made of the same material as the second electrode portion 51. When the fifth layer L5 is viewed in the first negative direction X2, the tenth electrode portion 55 has an L shape having the same dimension as the second electrode portion 51 and is located at the same position as the second electrode portion 51. Therefore, the tenth electrode portion 55 is laminated on the surface of the eighth electrode portion 54 facing the first negative direction X2. Since the dimension of the tenth electrode portion 55 is the same as the dimension of the second electrode portion 51, the maximum dimension of the tenth electrode portion 55 in the direction along the second axis Y is larger than the maximum dimension of the eighth electrode portion 54 in the direction along the second axis Y.

The third wiring portion 35 is made of the same material as the first wiring portion 31. When the fifth layer L5 is viewed in the first negative direction X2, the third wiring portion 35 extends as a whole in a spiral shape with the center of the fifth layer L5 as a substantial center. Specifically, the position of a first end portion 35A of the third wiring portion 35 is on the surface of the via 34 facing the first negative direction X2. Therefore, the first end portion 35A of the third wiring portion 35 is connected to the via 34. The wiring width of the third wiring portion 35 is substantially constant except for the first end portion 35A and a second end portion 35B. The position of the second end portion 35B of the third wiring portion 35 in the direction along the third axis Z is on the third negative direction Z2 side from the center of the fifth layer L5 in the direction along the third axis Z. The position of the second end portion 35B of the third wiring portion 35 in the direction along the second axis Y is on the second negative direction Y2 side from the center of the fifth layer L5 in the direction along the second axis Y. When the third wiring portion 35 is viewed in the first negative direction X2, the third wiring portion 35 extends clockwise from the first end portion 35A toward the second end portion 35B.

In the fifth layer L5, a portion excluding the ninth electrode portion 45, the tenth electrode portion 55, and the third wiring portion 35 is the fifth insulating portion 25. The fifth insulating portion 25 is made of a nonmagnetic insulator of the same material as the first insulating portion 21.

The sixth layer L6 is laminated on the main surface of the fifth layer L5 facing the first negative direction X2. When the sixth layer L6 is viewed in the first negative direction X2, the sixth layer L6 has the same rectangular shape as the first layer L1. The sixth layer L6 includes an eleventh electrode portion 46, a twelfth electrode portion 56, a via 36, and a sixth insulating portion 26.

The eleventh electrode portion 46 is made of the same material as the first electrode portion 41. When the sixth layer L6 is viewed in the first negative direction X2, the eleventh electrode portion 46 has an L shape having the same dimension as the third electrode portion 42 and is located at the same position as the third electrode portion 42. Therefore, the eleventh electrode portion 46 is laminated on the surface of the ninth electrode portion 45 facing the first negative direction X2. Since the dimension of the eleventh electrode portion 46 is the same as the dimension of the third electrode portion 42, the maximum dimension of the eleventh electrode portion 46 in the direction along the second axis Y is smaller than the maximum dimension of the ninth electrode portion 45 in the direction along the second axis Y.

The twelfth electrode portion 56 is made of the same material as the second electrode portion 51. When the sixth layer L6 is viewed in the first negative direction X2, the twelfth electrode portion 56 has an L shape having the same dimension as the fourth electrode portion 52 and is located at the same position as the fourth electrode portion 52. Therefore, the twelfth electrode portion 56 is laminated on the surface of the tenth electrode portion 55 facing the first negative direction X2. Since the dimension of the twelfth electrode portion 56 is the same as the dimension of the fourth electrode portion 52, the dimension of the twelfth electrode portion 56 in the direction along the second axis Y is smaller than the dimension of the tenth electrode portion 55 in the direction along the second axis Y.

The via 36 is made of the same material as the first wiring portion 31. The via 36 has a columnar shape extending in the direction along the first axis X. The via 36 is laminated on a surface of the second end portion 35B of the third wiring portion 35 facing the first negative direction X2. Therefore, the via 36 is electrically connected to the second end portion 35B of the third wiring portion 35. The via 36 extends from the second end portion 35B of the third wiring portion 35 in the first negative direction X2.

In the sixth layer L6, a portion excluding the eleventh electrode portion 46, the twelfth electrode portion 56, and the via 36 is the sixth insulating portion 26. The sixth insulating portion 26 is made of a nonmagnetic insulator of the same material as the first insulating portion 21.

The seventh layer L7 is laminated on the main surface of the sixth layer L6 facing the first negative direction X2. When the seventh layer L7 is viewed in the first negative direction X2, the seventh layer L7 has the same rectangular shape as the first layer L1. The seventh layer L7 includes a thirteenth electrode portion 47, a fourteenth electrode portion 57, a fourth wiring portion 37, and a seventh insulating portion 27.

The thirteenth electrode portion 47 is made of the same material as the first electrode portion 41. When the seventh layer L7 is viewed in the first negative direction X2, the thirteenth electrode portion 47 has an L shape having the same dimension as the first electrode portion 41 and is located at the same position as the first electrode portion 41. Therefore, the thirteenth electrode portion 47 is laminated on the surface of the eleventh electrode portion 46 facing the first negative direction X2. Since the dimension of the thirteenth electrode portion 47 is the same as the dimension of the first electrode portion 41, the maximum dimension of the thirteenth electrode portion 47 in the direction along the second axis Y is larger than the maximum dimension of the eleventh electrode portion 46 in the direction along the second axis Y.

The fourteenth electrode portion 57 is made of the same material as the second electrode portion 51. When the seventh layer L7 is viewed in the first negative direction X2, the fourteenth electrode portion 57 has an L shape having the same dimension as the second electrode portion 51 and is located at the same position as the second electrode portion 51. Therefore, the fourteenth electrode portion 57 is laminated on the surface of the twelfth electrode portion 56 facing the first negative direction X2. Since the dimension of the fourteenth electrode portion 57 is the same as the dimension of the second electrode portion 51, the maximum dimension of the fourteenth electrode portion 57 in the direction along the second axis Y is larger than the maximum dimension of the twelfth electrode portion 56 in the direction along the second axis Y.

The fourth wiring portion 37 is made of the same material as the first wiring portion 31. When the seventh layer L7 is viewed in the first negative direction X2, the fourth wiring portion 37 extends as a whole in a spiral shape with the center of the seventh layer L7 as a substantial center. Specifically, the position of a first end portion 37A of the fourth wiring portion 37 is on the surface of the via 36 facing the first negative direction X2. Therefore, the first end portion 37A of the fourth wiring portion 37 is connected to the via 36. The wiring width of the fourth wiring portion 37 is substantially constant except for the first end portion 37A and a second end portion 37B. The position of the second end portion 37B of the fourth wiring portion 37 in the direction along the third axis Z is on the third positive direction Z1 side from the center of the seventh layer L7 in the direction along the third axis Z. The position of the second end portion 37B of the fourth wiring portion 37 in the direction along the second axis Y is on the second negative direction Y2 side from the center of the seventh layer L7 in the direction along the second axis Y, and on the second negative direction Y2 side from the position of the first end portion 37A in the direction along the second axis Y. When the fourth wiring portion 37 is viewed in the first negative direction X2, the fourth wiring portion 37 extends clockwise from the first end portion 37A toward the second end portion 37B. The fourth wiring portion 37 is rotationally symmetric with the second wiring portion 33 with an axis in a direction along the third axis Z passing through the center in the extending direction of the inductor wiring 30 as a rotation axis.

In the seventh layer L7, a portion excluding the thirteenth electrode portion 47, the fourteenth electrode portion 57, and the fourth wiring portion 37 is the seventh insulating portion 27. The seventh insulating portion 27 is made of a nonmagnetic insulator of the same material as the first insulating portion 21.

The eighth layer L8 is laminated on the main surface of the seventh layer L7 facing the first negative direction X2. When the eighth layer L8 is viewed in the first negative direction X2, the eighth layer L8 has the same rectangular shape as the first layer L1. The eighth layer L8 includes a fifteenth electrode portion 48, a sixteenth electrode portion 58, a via 38, and an eighth insulating portion 28.

The fifteenth electrode portion 48 is made of the same material as the first electrode portion 41. When the eighth layer L8 is viewed in the first negative direction X2, the fifteenth electrode portion 48 has an L shape having the same dimension as the third electrode portion 42 and is located at the same position as the third electrode portion 42. Therefore, the fifteenth electrode portion 48 is laminated on the surface of the thirteenth electrode portion 47 facing the first negative direction X2. Since the dimension of the fifteenth electrode portion 48 is the same as the dimension of the third electrode portion 42, the maximum dimension of the fifteenth electrode portion 48 in the direction along the second axis Y is smaller than the maximum dimension of the thirteenth electrode portion 47 in the direction along the second axis Y.

The sixteenth electrode portion 58 is made of the same material as the second electrode portion 51. When the eighth layer L8 is viewed in the first negative direction X2, the sixteenth electrode portion 58 has an L shape having the same dimension as the fourth electrode portion 52 and is located at the same position as the fourth electrode portion 52. Therefore, the sixteenth electrode portion 58 is laminated on the surface of the fourteenth electrode portion 57 facing the first negative direction X2. Since the dimension of the sixteenth electrode portion 58 is the same as the dimension of the fourth electrode portion 52, the maximum dimension of the sixteenth electrode portion 58 in the direction along the second axis Y is smaller than the maximum dimension of the fourteenth electrode portion 57 in the direction along the second axis Y.

The via 38 is made of the same material as the first wiring portion 31. The via 38 has a columnar shape extending in the direction along the first axis X. The via 38 is laminated on a surface of the second end portion 37B of the fourth wiring portion 37 facing the first negative direction X2. Therefore, the via 38 is electrically connected to the second end portion 37B of the fourth wiring portion 37. The via 38 extends from the second end portion 37B of the fourth wiring portion 37 in the first negative direction X2.

In the eighth layer L8, a portion excluding the fifteenth electrode portion 48, the sixteenth electrode portion 58, and the via 38 is the eighth insulating portion 28. The eighth insulating portion 28 is made of a nonmagnetic insulator of the same material as the first insulating portion 21.

The ninth layer L9 is laminated on the main surface of the eighth layer L8 facing the first negative direction X2. When the ninth layer L9 is viewed in the first negative direction X2, the ninth layer L9 has the same rectangular shape as the first layer L1. The ninth layer L9 includes a seventeenth electrode portion 49, an eighteenth electrode portion 59, a fifth wiring portion 39, and a ninth insulating portion 29.

The seventeenth electrode portion 49 is made of the same material as the first electrode portion 41. When the ninth layer L9 is viewed in the first negative direction X2, the seventeenth electrode portion 49 has an L shape having the same dimension as the first electrode portion 41 and is located at the same position as the first electrode portion 41. Therefore, the seventeenth electrode portion 49 is laminated on the surface of the fifteenth electrode portion 48 facing the first negative direction X2. Since the dimension of the seventeenth electrode portion 49 is the same as the dimension of the first electrode portion 41, the maximum dimension of the seventeenth electrode portion 49 in the direction along the second axis Y is larger than the maximum dimension of the fifteenth electrode portion 48 in the direction along the second axis Y.

The eighteenth electrode portion 59 is made of the same material as the second electrode portion 51. When the ninth layer L9 is viewed in the first negative direction X2, the eighteenth electrode portion 59 has an L shape having the same dimension as the second electrode portion 51 and is located at the same position as the second electrode portion 51. Therefore, the eighteenth electrode portion 59 is laminated on the surface of the sixteenth electrode portion 58 facing the first negative direction X2. Since the dimension of the eighteenth electrode portion 59 is the same as the dimension of the second electrode portion 51, the maximum dimension of the eighteenth electrode portion 59 in the direction along the second axis Y is larger than the maximum dimension of the sixteenth electrode portion 58 in the direction along the second axis Y.

The fifth wiring portion 39 is made of the same material as the first wiring portion 31. When the ninth layer L9 is viewed in the first negative direction X2, the fifth wiring portion 39 extends as a whole in a spiral shape with the center of the ninth layer L9 as a center. Specifically, the position of a first end portion 39A of the fifth wiring portion 39 is on the surface of the via 38 facing the first negative direction X2. Therefore, the first end portion 39A of the fifth wiring portion 39 is connected to the via 38. The wiring width of the fifth wiring portion 39 is substantially constant except for the first end portion 39A. A second end portion 39B of the fifth wiring portion 39 is connected to an end portion of the eighteenth electrode portion 59 on the third positive direction Z1 side in the direction along the third axis Z. When the fifth wiring portion 39 is viewed in the first negative direction X2, the fifth wiring portion 39 extends clockwise from the first end portion 39A toward the second end portion 39B. The second end portion 39B of the fifth wiring portion 39 is a second end portion of the inductor wiring 30. The fifth wiring portion 39 is rotationally symmetric with the first wiring portion 31 with an axis in a direction along the third axis Z passing through the center in the extending direction of the inductor wiring 30 as a rotation axis. The second end portion 39B is a portion deviated from the circling path CR configured by overlapping the wiring portions of the first layer L1 to the ninth layer L9 when viewed in the first negative direction X2. The circling path CR will be described later.

In the ninth layer L9, a portion excluding the seventeenth electrode portion 49, the eighteenth electrode portion 59, and the fifth wiring portion 39 is the ninth insulating portion 29. The ninth insulating portion 29 is made of an insulator of the same material as that of the first insulating portion 21.

The element body 11 includes a first covering insulating layer 61 and a second covering insulating layer 62. When the first covering insulating layer 61 is viewed in the first negative direction X2, the first covering insulating layer 61 has the same rectangular shape as the first layer L1. The first covering insulating layer 61 is laminated on a main surface of the first layer L1 facing the first positive direction X1. When the second covering insulating layer 62 is viewed in the first positive direction X1, the second covering insulating layer 62 has the same rectangular shape as the first layer L1. The second covering insulating layer 62 is laminated on the main surface of the ninth layer L9 facing the first negative direction X2. The first covering insulating layer 61 may have a configuration in which a plurality of insulating layers are laminated. When the first covering insulating layer 61 includes a plurality of insulating layers, some of the insulating layers may be colored.

The first insulating portion 21 to the ninth insulating portion 29, the first covering insulating layer 61, and the second covering insulating layer 62 described above are integrated. Note that there may be or may not be a physical boundary between the portions of the insulating portion 20. Hereinafter, in a case where it is not necessary to distinguish these, they are collectively referred to as an insulating portion 20.

In addition, the first wiring portion 31, the second wiring portion 33, the third wiring portion 35, the fourth wiring portion 37, the fifth wiring portion 39, the via 32, the via 34, the via 36, and the via 38 are integrated. Note that there may be or may not be a physical boundary between the portions of the inductor wiring 30. Hereinafter, in a case where it is not necessary to distinguish them, they are collectively referred to as the inductor wiring 30. The inductor wiring 30 is spirally wound as a whole. The central axis when the inductor wiring 30 is wound is an axis extending along the first axis X.

Furthermore, the first electrode portion 41, the third electrode portion 42, the fifth electrode portion 43, the seventh electrode portion 44, the ninth electrode portion 45, the eleventh electrode portion 46, the thirteenth electrode portion 47, the fifteenth electrode portion 48, and the seventeenth electrode portion 49 described above are integrated. Then, these are combined to form the first electrode 40.

Similarly, the second electrode portion 51, the fourth electrode portion 52, the sixth electrode portion 53, the eighth electrode portion 54, the tenth electrode portion 55, the twelfth electrode portion 56, the fourteenth electrode portion 57, the sixteenth electrode portion 58, and the eighteenth electrode portion 59 described above are integrated. Then, these are combined to form the second electrode 50.

In the present embodiment, the insulating portion 20, the first electrode 40, and the second electrode 50 constitute the element body 11 of the inductor component 10. The inductor wiring 30 extends inside the element body 11. Note that the inductor wiring 30, the first electrode 40, and the second electrode 50 may be integrated. That is, there may be no physical boundary between the inductor wiring 30 and the first electrode 40 or between the inductor wiring 30 and the second electrode 50.

As a result of laminating the first layer L1 to the ninth layer L9, the first covering insulating layer 61, and the second covering insulating layer 62, the element body 11 has a rectangular parallelepiped shape as a whole as illustrated in FIG. 1. Note that there may be or may not be a physical boundary between the first layer L1 to the ninth layer L9, the first covering insulating layer 61, and the second covering insulating layer 62. In addition, not only the insulating portion 20 but also the electrode portions and the wiring portions and the vias may be integrated between the layers. As illustrated in FIG. 3, the first electrode 40 is exposed to the outside of the element body 11 in a region from the first end surface 11C to the bottom surface 11E. In addition, the second electrode 50 is exposed to the outside of the element body 11 in a region from the second end surface 11D to the bottom surface 11E.

As illustrated in FIG. 1, the inductor component 10 includes a first covering electrode 71 and a second covering electrode 72. The first covering electrode 71 covers a surface of the first electrode 40 exposed to the outside from the element body 11. Although not illustrated, the first covering electrode 71 has a two-layer structure of nickel plating and tin plating. That is, the first electrode 40 being exposed to the outside of the element body 11 means that the first electrode 40 only needs to be exposed to the outside of the element body 11, and includes a case where the first electrode 40 is covered with a covering film such as the first covering electrode 71 which is plating.

The second covering electrode 72 covers a surface of the second electrode 50 exposed to the outside from the element body 11. Although not illustrated, the second covering electrode 72 has a two-layer structure of nickel plating and tin plating. That is, the second electrode 50 being exposed to the outside of the element body 11 means that the second electrode 50 may be covered with the second covering electrode 72 which is plating. In FIGS. 2 and 3, illustration of the first covering electrode 71 and the second covering electrode 72 is omitted.

(Circling Path of Inductor Wiring)

As illustrated in FIG. 3, the inductor wiring 30 as a whole extends in a spiral shape with the center axis extending in a direction along the first axis X as a winding center. As illustrated in FIG. 2, each of the first wiring portion 31, the second wiring portion 33, the third wiring portion 35, the fourth wiring portion 37, and the fifth wiring portion 39 extends in parallel to the first main surface 11A.

Here, as illustrated in FIG. 3, when the inductor wiring 30 is viewed in the first negative direction X2, the first wiring portion 31, the second wiring portion 33, the third wiring portion 35, the fourth wiring portion 37, and the fifth wiring portion 39 have a circling path CR. When the inductor wiring 30 is viewed in the first negative direction X2, the circling path CR is wound in an annular one turn.

The circling path CR includes an upper side portion P1, a lower side portion P2, a first side portion P3, a second side portion P4, a first oblique side portion P5, and a second oblique side portion P6.

The upper side portion P1 extends parallel to the second axis Y. The upper side portion P1 includes a portion of the inductor wiring 30 closest to the top surface 11F. That is, when the inductor wiring 30 is viewed in the first negative direction X2, the upper side portion P1 is a portion including a portion closest to the top surface 11F in a portion where the first wiring portion 31 and the second wiring portion 33 overlap each other and extending parallel to the second axis Y.

The lower side portion P2 extends parallel to the second axis Y. The lower side portion P2 includes a portion of the inductor wiring 30 closest to the bottom surface 11E. That is, when the inductor wiring 30 is viewed in the first negative direction X2, the lower side portion P2 is a portion including a portion closest to the bottom surface 11E in a portion where the first wiring portion 31 and the second wiring portion 33 overlap each other and extending parallel to the second axis Y. The dimension of the lower side portion P2 in the direction along the second axis Y is smaller than the dimension of the upper side portion P1 in the direction along the second axis Y. An end of the lower side portion P2 on the second positive direction Y1 side is located on the second negative direction Y2 side with respect to an end of the upper side portion P1 on the second positive direction Y1 side. An end of the lower side portion P2 on the second negative direction Y2 side is located on the second positive direction Y1 side with respect to an end of the upper side portion P1 on the second negative direction Y2 side.

The first side portion P3 extends parallel to the third axis Z. When the inductor wiring 30 is viewed in the first negative direction X2, an end of the first side portion P3 on the third positive direction Z1 side coincides with the position of an end of the upper side portion P1 on the second positive direction Y1 side. An end of the first side portion P3 on the third negative direction Z2 side is located on the second positive direction Y1 side and the third positive direction Z1 side with respect to the end of the lower side portion P2 on the second positive direction Y1 side.

The second side portion P4 extends parallel to the third axis Z. When the inductor wiring 30 is viewed in the first negative direction X2, an end of the second side portion P4 on the third positive direction Z1 side coincides with a position of an end of the upper side portion P1 on the second negative direction Y2 side. An end of the second side portion P4 on the third negative direction Z2 side is located on the second negative direction Y2 side and the third positive direction Z1 side with respect to an end of the lower side portion P2 on the second negative direction Y2 side.

The first oblique side portion P5 extends linearly so as to be oblique to both the second axis Y and the third axis Z. Specifically, the first oblique side portion P5 extends obliquely so as to be located on the third negative direction Z2 side toward the second negative direction Y2 side. An end of the first oblique side portion P5 on the third positive direction Z1 side coincides with the position of the end of the first side portion P3 on the third negative direction Z2 side. An end of the first oblique side portion P5 on the third negative direction Z2 side coincides with the position of the end of the lower side portion P2 on the second positive direction Y1 side.

The second oblique side portion P6 extends linearly so as to be oblique to both the second axis Y and the third axis Z. Specifically, the second oblique side portion P6 extends obliquely so as to be located on the third negative direction Z2 side toward the second positive direction Y1 side. An end of the second oblique side portion P6 on the third positive direction Z1 side coincides with a position of an end of the second side portion P4 on the third negative direction Z2 side. An end of the second oblique side portion P6 on the third negative direction Z2 side coincides with a position of an end of the lower side portion P2 on the second negative direction Y2 side.

In this manner, it is assumed that the inductor wiring 30 is traced from the first electrode 40 toward the second electrode 50 when the inductor wiring 30 is viewed in the first negative direction X2. In this case, the circling path CR circles clockwise in the order of the upper side portion P1, the second side portion P4, the second oblique side portion P6, the lower side portion P2, the first oblique side portion P5, and the first side portion P3.

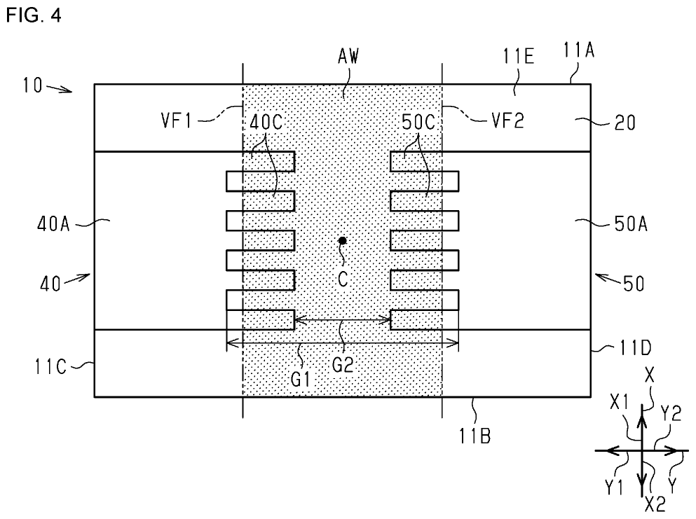

The maximum dimension of the circling path CR in the direction along the second axis Y is the maximum dimension of the upper side portion P1 in the direction along the second axis Y. The maximum dimension of the upper side portion P1 in the direction along the second axis Y is the dimension of the outer edge of the upper side portion P1 when viewed from the rotation center in the circling path CR. The maximum dimension of the lower side portion P2 in the direction along the second axis Y is the dimension of the outer edge of the lower side portion P2 when viewed from the rotation center in the circling path CR. The maximum dimension of the lower side portion P2 in the direction along the second axis Y is smaller than the maximum dimension of the upper side portion P1 in the direction along the second axis Y. That is, the maximum dimension of the lower side portion P2 in the direction along the second axis Y is smaller than the maximum dimension of the circling path CR in the direction along the second axis Y. In the following description, a range from a first virtual plane VF1 to a second virtual plane VF2 in the element body 11 is defined as a wiring range AW. The first virtual plane VF1 is a virtual plane including an end of the lower side portion P2 on the first end surface 11C side and parallel to the first end surface 11C. The second virtual plane VF2 is a virtual plane including an end of the lower side portion P2 on the second end surface 11D side and parallel to the first end surface 11C. That is, the wiring range AW is a range overlapping the shadow when the lower side portion P2 is projected from all directions perpendicular to the second axis Y in the element body 11, and is the entire region in the direction perpendicular to the first main surface 11A and the entire region in the direction perpendicular to the bottom surface 11E. In FIGS. 3 and 4, the wiring range AW is indicated by dots.

(Bottom Surface Electrode Portion and Protrusion Portion)

As illustrated in FIG. 3, the first electrode 40 is exposed to the outside of the element body 11 in a region from the first end surface 11C to the bottom surface 11E. The first electrode 40 includes a first bottom surface electrode portion 40A, a first end surface electrode portion 40B, and five first protrusion portions 40C.

As illustrated in FIG. 4, the first bottom surface electrode portion 40A is exposed to the outside of the element body 11 at the bottom surface 11E. The first bottom surface electrode portion 40A has a plate shape. When the bottom surface 11E is viewed in the third positive direction Z1, the first bottom surface electrode portion 40A has a quadrangular shape. When the bottom surface 11E is viewed in the third positive direction Z1, the side of the first bottom surface electrode portion 40A on the second positive direction Y1 side coincides with the first end surface 11C of the element body 11. Therefore, the end of the first bottom surface electrode portion 40A on the second positive direction Y1 side in the bottom surface 11E coincides with the end of the bottom surface 11E on the second positive direction Y1 side. When the bottom surface 11E is viewed in the third positive direction Z1, the side of the first bottom surface electrode portion 40A on the second negative direction Y2 side is located on the second positive direction Y1 side with respect to the end of the lower side portion P2 on the second positive direction Y1 side. Therefore, the first bottom surface electrode portion 40A is located only within the range from the first end surface 11C to the end on the first end surface 11C side in the wiring range AW.

As illustrated in FIG. 3, the first end surface electrode portion 40B is exposed to the outside of the element body 11 at the first end surface 11C. The first end surface electrode portion 40B has a plate shape. When the first end surface 11C is viewed in the second negative direction Y2, the first end surface electrode portion 40B has a quadrangular shape. When the first end surface 11C is viewed in the second negative direction Y2, a side of the first end surface electrode portion 40B on the third negative direction Z2 side is in contact with a surface of the first bottom surface electrode portion 40A facing the third positive direction Z1. That is, the first end surface electrode portion 40B extends in the third positive direction Z1 from the end of the first bottom surface electrode portion 40A on the second positive direction Y1 side.

As illustrated in FIG. 4, the first protrusion portions 40C are exposed to the outside of the element body 11 at the bottom surface 11E. The first protrusion portions 40C protrude in the second negative direction Y2 from an end of the first bottom surface electrode portion 40A on the second negative direction Y2 side. That is, the first protrusion portions 40C protrude from the end of the first bottom surface electrode portion 40A on the second end surface 11D side toward the second end surface 11D side. A part of the first protrusion portion 40C on the second negative direction Y2 side in the bottom surface 11E is located within the wiring range AW.

That is, as illustrated in FIGS. 2 and 4, portions of the first electrode portion 41, the fifth electrode portion 43, the ninth electrode portion 45, the thirteenth electrode portion 47, and the seventeenth electrode portion 49 that protrude in the second negative direction Y2 from the end of the third electrode portion 42 on the second negative direction Y2 side are the first protrusion portions 40C. Therefore, the maximum dimension of the first protrusion portion 40C in the direction along the first axis X is smaller than the maximum dimension of the first bottom surface electrode portion 40A in the direction along the first axis X. Specifically, the maximum dimension of the first protrusion portion 40C in the direction along the first axis X is the dimension of the first layer L1 in the direction along the first axis X. The maximum dimension of the first bottom surface electrode portion 40A in the direction along the first axis X is a total value of the dimensions of the first layer L1 to the ninth layer L9 in the direction along the first axis X.

As illustrated in FIG. 3, the maximum dimension of the first electrode portion 41 in the direction along the second axis Y is smaller than ½ times the dimension of the first layer L1 in the direction along the second axis Y. The maximum dimension of the first electrode portion 41 in the direction along the second axis Y is ¼ times or more the dimension of the first layer L1 in the direction along the second axis Y. Therefore, the maximum dimension from the first end surface 11C to the end of the first protrusion portion 40C on the second negative direction Y2 side is ¼ times or more and less than ½ times (i.e., from ¼ times to less than ½ times) the maximum dimension of the bottom surface 11E in the direction along the second axis Y.

The five first protrusion portions 40C are present in the first layer L1, the third layer L3, the fifth layer L5, the seventh layer L7, and the ninth layer L9, respectively. Therefore, the first protrusion portions 40C are present only in the layers where the first wiring portion 31, the second wiring portion 33, the third wiring portion 35, the fourth wiring portion 37, and the fifth wiring portion 39 are present in the direction along the first axis X. That is, the first protrusion portion 40C is present only in the layer where each wiring portion of the inductor wiring 30 is present in the direction perpendicular to the first main surface 11A.

As illustrated in FIG. 3, similarly to the first electrode 40, the second electrode 50 is exposed to the outside of the element body 11 in a region from the second end surface 11D to the bottom surface 11E. The second electrode 50 includes a second bottom surface electrode portion 50A, a second end surface electrode portion 50B, and five second protrusion portions 50C.

As illustrated in FIG. 4, the second bottom surface electrode portion 50A is exposed to the outside of the element body 11 at the bottom surface 11E. The second bottom surface electrode portion 50A has a plate shape. When the bottom surface 11E is viewed in the third positive direction Z1, the second bottom surface electrode portion 50A has a quadrangular shape. When the bottom surface 11E is viewed in the third positive direction Z1, the side of the second bottom surface electrode portion 50A on the second negative direction Y2 side coincides with the second end surface 11D of the element body 11. Therefore, the end of the second bottom surface electrode portion 50A on the second negative direction Y2 side in the bottom surface 11E coincides with the end of the bottom surface 11E on the second negative direction Y2 side. When the bottom surface 11E is viewed in the third positive direction Z1, the side of the second bottom surface electrode portion 50A on the second positive direction Y1 side is located on the second negative direction Y2 side with respect to the end of the lower side portion P2 on the second negative direction Y2 side. Therefore, the second bottom surface electrode portion 50A is located only within the range from the second end surface 11D to the end on the second end surface 11D side in the wiring range AW.

As illustrated in FIG. 3, the second end surface electrode portion 50B is exposed to the outside of the element body 11 at the second end surface 11D. The second end surface electrode portion 50B has a plate shape. When the second end surface 11D is viewed in the second positive direction Y1, the second end surface electrode portion 50B has a quadrangular shape. When the second end surface 11D is viewed in the second positive direction Y1, a side of the second end surface electrode portion 50B on the third negative direction Z2 side is in contact with a surface of the second bottom surface electrode portion 50A facing the third positive direction Z1. That is, the second end surface electrode portion 50B extends in the third positive direction Z1 from an end of the second bottom surface electrode portion 50A on the second negative direction Y2 side.

As illustrated in FIG. 4, the second protrusion portions 50C are exposed to the outside of the element body 11 at the bottom surface 11E. The second protrusion portions 50C protrude in the second positive direction Y1 from an end of the second bottom surface electrode portion 50A on the second positive direction Y1 side. That is, the second protrusion portions 50C protrude from the end of the second bottom surface electrode portion 50A on the first end surface 11C side toward the first end surface 11C side. A part of the second protrusion portion 50C on the second positive direction Y1 side in the bottom surface 11E is located within the wiring range AW.

That is, as illustrated in FIGS. 2 and 4, portions of the second electrode portion 51, the sixth electrode portion 53, the tenth electrode portion 55, the fourteenth electrode portion 57, and the eighteenth electrode portion 59 that protrude in the second positive direction Y1 from the end of the fourth electrode portion 52 on the second positive direction Y1 side are the second protrusion portions 50C. Therefore, the maximum dimension of the second protrusion portion 50C in the direction along the first axis X is smaller than the maximum dimension of the second bottom surface electrode portion 50A in the direction along the first axis X. Specifically, the maximum dimension of the second protrusion portion 50C in the direction along the first axis X is the dimension of the first layer L1 in the direction along the first axis X. The maximum dimension of the second bottom surface electrode portion 50A in the direction along the first axis X is a total value of the dimensions of the first layer L1 to the ninth layer L9 in the direction along the first axis X.

As illustrated in FIG. 3, the maximum dimension of the second electrode portion 51 in the direction along the second axis Y is smaller than ½ times the dimension of the first layer L1 in the direction along the second axis Y. The maximum dimension of the second electrode portion 51 in the direction along the second axis Y is ¼ times or more the dimension of the first layer L1 in the direction along the second axis Y. Therefore, the maximum dimension from the second end surface 11D to the end of the second protrusion portion 50C on the second positive direction Y1 side is ¼ times or more and less than ½ times (i.e., from ¼ times to less than ½ times) the maximum dimension of the bottom surface 11E in the direction along the second axis Y.

The five second protrusion portions 50C are present in the first layer L1, the third layer L3, the fifth layer L5, the seventh layer L7, and the ninth layer L9, respectively. Therefore, the second protrusion portions 50C are present only in the layers where the first wiring portion 31, the second wiring portion 33, the third wiring portion 35, the fourth wiring portion 37, and the fifth wiring portion 39 are present in the direction along the first axis X. That is, the second protrusion portion 50C is present only in the layer where each wiring portion of the inductor wiring 30 is present in the direction perpendicular to the first main surface 11A.

The dimension of the second bottom surface electrode portion 50A is equal to the dimension of the first bottom surface electrode portion 40A. The dimension of the second protrusion portion 50C is equal to the dimension of the first protrusion portion 40C. Therefore, when the bottom surface 11E is viewed in the third positive direction Z1, the shape in which the first electrode 40 is exposed on the bottom surface 11E is a two-fold rotational symmetry shape centered on the geometric center C of the bottom surface 11E with respect to the shape in which the second electrode 50 is exposed on the bottom surface 11E.

(Gap Between Electrodes)

As illustrated in FIG. 4, in the bottom surface 11E, an interval between an end of the first bottom surface electrode portion 40A on the second negative direction Y2 side in the direction along the second axis Y and the second electrode 50 is defined as a first gap Gl. The first gap G1 is a minimum distance between the end of the first bottom surface electrode portion 40A on the second negative direction Y2 side and the end of the second bottom surface electrode portion 50A on the second positive direction Y1 side. The first gap G1 is larger than the dimension of the wiring range AW in the direction along the second axis Y.

On the other hand, in the bottom surface 11E, an interval between the end of the first protrusion portion 40C on the second negative direction Y2 side in the direction along the second axis Y and the second electrode 50 is defined as a second gap G2. The second gap G2 is a minimum distance between the end of the first protrusion portion 40C on the second negative direction Y2 side and the end of the second protrusion portion 50C on the second positive direction Y1 side. The second gap G2 is smaller than the dimension of the wiring range AW in the direction along the second axis Y.

### Effects of Embodiment

According to the above embodiment, the following effects are obtained. Note that effects common to the first electrode 40 and the second electrode 50 will be described with the first electrode 40 as a representative, and the description of the second electrode 50 will be omitted.

(1) According to the above embodiment, a part of the first protrusion portion 40C on the second negative direction Y2 side is located within the wiring range AW. Therefore, the area where the first electrode 40 is exposed to the bottom surface 11E can be sufficiently secured. Therefore, when the first electrode 40 is fixed to a substrate or the like, it is possible to suppress insufficiency of the fixing force of the inductor component 10 to the substrate or the like. Although the first protrusion portion 40C is located within the wiring range AW, the maximum dimension of the first protrusion portion 40C in the direction along the first axis X is smaller than the maximum dimension of the first bottom surface electrode portion 40A in the direction along the first axis X. Therefore, the stray capacitance generated between the first electrode 40 and the inductor wiring 30 can be reduced as compared with the case where the first bottom surface electrode portion 40A itself is located within the wiring range AW.

(2) According to the above embodiment, the maximum dimension from the first end surface 11C to the end of the first protrusion portion 40C on the second negative direction Y2 side is ¼ times or more the maximum dimension of the bottom surface 11E in the direction along the second axis Y. Therefore, it is possible to secure a necessary and sufficient area as an area exposed to the bottom surface 11E of the first electrode 40. The maximum dimension from the first end surface 11C to the end of the first protrusion portion 40C on the second negative direction Y2 side is less than ½ times the maximum dimension of the bottom surface 11E in the direction along the second axis Y. Therefore, it is possible to prevent generation of a defective product in which the first electrode 40 and the second electrode 50 are in contact with each other due to a manufacturing error or the like.

(3) According to the above embodiment, the second gap G2 is smaller than the dimension of the wiring range AW in the direction along the second axis Y. Therefore, the total area of the area in which the first electrode 40 is exposed at the bottom surface 11E and the area in which the second electrode 50 is exposed at the bottom surface 11E is considerably large. Therefore, the inductor component 10 can be more firmly fixed to the substrate or the like.

(4) According to the above embodiment, the maximum dimension of the lower side portion P2 in the direction along the second axis Y is smaller than the maximum dimension of the circling path CR in the direction along the second axis Y. That is, at the same position in the direction along the third axis Z as the lower side portion P2, a wiring portion is not present in the portion on the second positive direction Y1 side with respect to the lower side portion P2. Therefore, if the first bottom surface electrode portion 40A is located on the second positive direction Y1 side with respect to the end of the lower side portion P2 on the second positive direction Y1 side, a sufficient distance from the circling path CR can be secured. Therefore, it is easy to design so that the exposed area of the first bottom surface electrode portion 40A on the bottom surface 11E becomes sufficient while avoiding the first bottom surface electrode portion 40A from excessively approaching the circling path CR.

(5) If the first protrusion portion 40C is provided in the layer where each via is present, in order to prevent the first protrusion portion 40C from coming into contact with the inductor wiring 30, it is necessary to design while paying attention to contact with each wiring portion in another layer. According to the above embodiment, the five first protrusion portions 40C are present only in the layers where the first wiring portion 31, the second wiring portion 33, the third wiring portion 35, the fourth wiring portion 37, and the fifth wiring portion 39 are located. Therefore, the five first protrusion portions 40C are not present in the layers where the via 32, the via 34, the via 36, and the via 38 are located. Therefore, in designing the first protrusion portion 40C so as not to come into contact with the inductor wiring 30, it is sufficient to consider the arrangement in the same layer, and thus it is easy to design.

(6) According to the above embodiment, similarly to the first protrusion portion 40C of the first electrode 40, also in the second electrode 50, a part of the second protrusion portion 50C on the second negative direction Y2 side is located within the wiring range AW. Therefore, in addition to the first electrode 40, the area where the second electrode 50 is exposed to the bottom surface 11E can be sufficiently secured. Also in the second electrode 50, the stray capacitance generated between the second electrode 50 and the inductor wiring 30 can be reduced as compared with the case where the second bottom surface electrode portion 50A itself is located within the wiring range AW.

### OTHER EMBODIMENTS

The above embodiment can be modified as below and be implemented. The above embodiment and the following modifications can be implemented in combination within a range not technically contradictory. The common point between the first electrode 40 and the second electrode 50 will be described as a representative of the first electrode 40, and the description of the second electrode 50 will be omitted.

The thicknesses of the first layer L1 to the ninth layer L9, that is, the dimensions in the direction along the first axis X are not necessarily the same. All the thicknesses may be different from each other, or the thicknesses of some layers may be different from the thicknesses of other layers.

The element body 11 may be a rectangular parallelepiped that is long in the direction along the first axis X or a rectangular parallelepiped that is long in the direction along the third axis Z. Further, the element body 11 may be a rectangular parallelepiped having the same dimension in the direction along the first axis X, the same dimension in the direction along the second axis Y, and the same dimension in the direction along the third axis Z. For example, with respect to the dimension in the direction along each axis of the element body 11, the dimension in the direction along the first axis X may be equal to the dimension in the direction along the third axis Z, and the dimension in the direction along the second axis Y may be larger than the dimension in the direction along the first axis X. For example, with respect to the dimension in the direction along each axis of the element body 11, the dimension in the direction along the second axis Y may be larger than the dimension in the direction along the third axis Z, and the dimension in the direction along the third axis Z may be larger than the dimension in the direction along the first axis X. For example, the dimension in the direction along the second axis Y may be larger than the dimension in the direction along the first axis X, and the dimension in the direction along the first axis X may be larger than the dimension in the direction along the third axis Z.

The material of the insulating portion 20 is not limited to the example of the above embodiment, and may be an insulator. For example, the material of the insulating portion 20 may be a magnetic insulator. In addition, a part of the insulating portion 20 may be a nonmagnetic or magnetic insulator different from other portions.

The first covering electrode 71 and the second covering electrode 72 can be omitted. When the first covering electrode 71 is provided on the first electrode 40 by plating, in the process of forming the first covering electrode 71, the first covering electrode 71 may spread more than the range of the first electrode 40 exposed to the bottom surface 11E. That is, when viewed in a direction perpendicular to the bottom surface 11E, the shape of the first covering electrode 71 may not coincides with the shape of the first electrode 40. Even in such a case, on the bottom surface 11E, the first bottom surface electrode portion 40A may be located outside the wiring range AW, and a part of the first protrusion portion 40C may be located within the wiring range AW.

(First Electrode and Second Electrode)

The dimension of the first electrode 40 exposed to the bottom surface 11E is not limited to the example of the above embodiment. For example, the first bottom surface electrode portion 40A may extend in the bottom surface 11E in the entire direction along the first axis X. For example, the maximum dimension from the first end surface 11C to the end of the first protrusion portion 40C on the second negative direction Y2 side may be less than ¼ times or ½ times or more the maximum dimension of the bottom surface 11E in the direction along the second axis Y. At least a part of the first protrusion portion 40C may be located within the wiring range AW. However, the first electrode 40 needs to be separated from the second electrode 50.

The number of the first protrusion portions 40C included in the first electrode 40 may be four or less or six or more. The positions of the first protrusion portions 40C in the direction along the first axis X can also be appropriately adjusted.

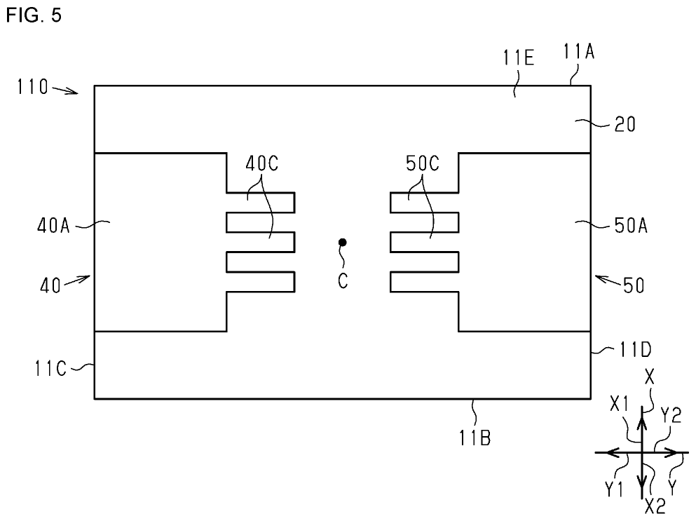

For example, in an inductor component 110 of a modification illustrated in FIG. 5, the number and positions of the first protrusion portions 40C are different from those of the inductor component 10 of the above embodiment. In the inductor component 110, the number and positions of the second protrusion portions 50C are different from those of the inductor component 10 of the above embodiment. Specifically, in the inductor component 110, the first electrode 40 has three first protrusion portions 40C. The first protrusion portions 40C are present in the third layer L3, the fifth layer L5, and the seventh layer L7 illustrated in FIG. 2, respectively. That is, the first protrusion portion 40C is not present in the first layer L1 and the ninth layer L9. In the inductor component 110, the second electrode 50 has three second protrusion portions 50C. The second protrusion portions 50C are present in the third layer L3, the fifth layer L5, and the seventh layer L7 illustrated in FIG. 2, respectively That is, the second protrusion portion 50C is not present in the first layer L1 and the ninth layer L9.

In the plurality of wiring portions of the inductor wiring 30, a wiring portion extending in parallel to the first main surface 11A from the first end of the inductor wiring 30 is defined as a first end wiring portion. In the plurality of wiring portions of the inductor wiring 30, a wiring portion extending in parallel to the first main surface 11A from the second end of the inductor wiring 30 is defined as a second end wiring portion. In this case, the first end wiring portion is the first wiring portion 31. The second end wiring portion is the fifth wiring portion 39. The fifth wiring portion 39 which is the second end wiring portion is not present in the same layer as the first wiring portion 31 which is the first end wiring portion.

In the inductor component 110 of the modification illustrated in FIG. 5, the first protrusion portion 40C is not present in the layer where the fifth wiring portion 39 as the second end wiring portion is present. That is, the first protrusion portion 40C is not present in the same layer as the layer where the fifth wiring portion 39 is present in the direction perpendicular to the first main surface 11A. Similarly to the first protrusion portion 40C, also in the second electrode 50, the second protrusion portion 50C is not present in the layer where the first wiring portion 31 as the first end wiring portion is present. That is, the second protrusion portion 50C is not present in the same layer as the layer where the first wiring portion 31 is present in the direction perpendicular to the first main surface 11A.

According to the inductor component 110 of the modification illustrated in FIG. 5, there is a considerable distance between the first electrode 40 and the fifth wiring portion 39 which is the second end wiring portion on the path of the inductor wiring 30. Therefore, when a current flows through the inductor wiring 30, a non-negligible potential difference is generated between the first electrode 40 and the fifth wiring portion 39 which is the second end wiring portion. If the first protrusion portion 40C is present in the ninth layer L9 where the fifth wiring portion 39 is present, a large stray capacitance may be generated by the first protrusion portion 40C. According to the inductor component 110 of the above-described modification, since the first protrusion portion 40C is not present in the ninth layer L9 where the fifth wiring portion 39 is present, it is possible to suppress generation of a large stray capacitance.

When the bottom surface 11E is viewed in the third positive direction Z1, the shape in which the first electrode 40 is exposed on the bottom surface 11E may not be a two-fold rotational symmetry shape centered on the geometric center C of the bottom surface 11E with respect to the shape in which the second electrode 50 is exposed on the bottom surface 11E. In this case, by observing the shape of the electrode on the bottom surface 11E, the first end surface 11C side and the second end surface 11D side of the inductor component 10 can be grasped.

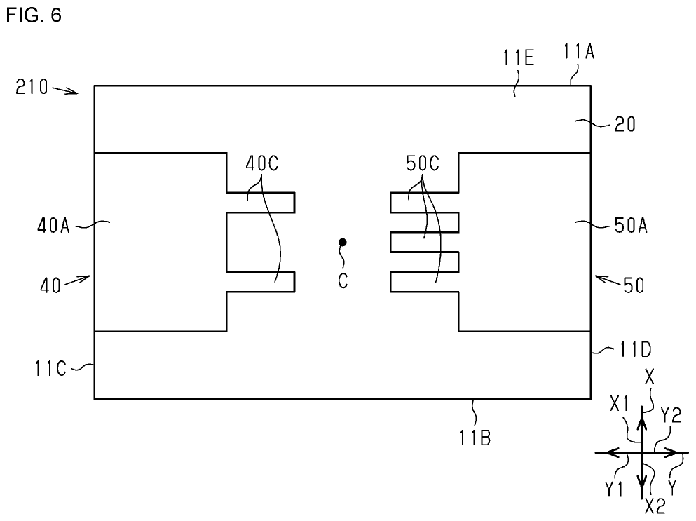

For example, in an inductor component 210 of a modification illustrated in FIG. 6, the number of the first protrusion portions 40C is different from that of the inductor component 110 of the modification illustrated in FIG. 5. Specifically, the first electrode 40 has two first protrusion portions 40C. The first protrusion portion 40C is present in each of the third layer L3 and the seventh layer L7. On the other hand, the second electrode 50 has three second protrusion portions 50C. The second protrusion portion 50C is present in each of the third layer L3, the fifth layer L5, and the seventh layer L7. Therefore, when the bottom surface 11E is viewed in the third positive direction Z1, the shape in which the first electrode 40 is exposed on the bottom surface 11E is not a two-fold rotational symmetry shape centered on the geometric center C of the bottom surface 11E with respect to the shape in which the second electrode 50 is exposed on the bottom surface 11E. As a result, if the shape and the dimension of the first bottom surface electrode portion 40A are the same as the shape and the dimension of the second bottom surface electrode portion 50A, the first electrode 40 and the second electrode 50 can be distinguished from each other because the number of protrusion portions is different.

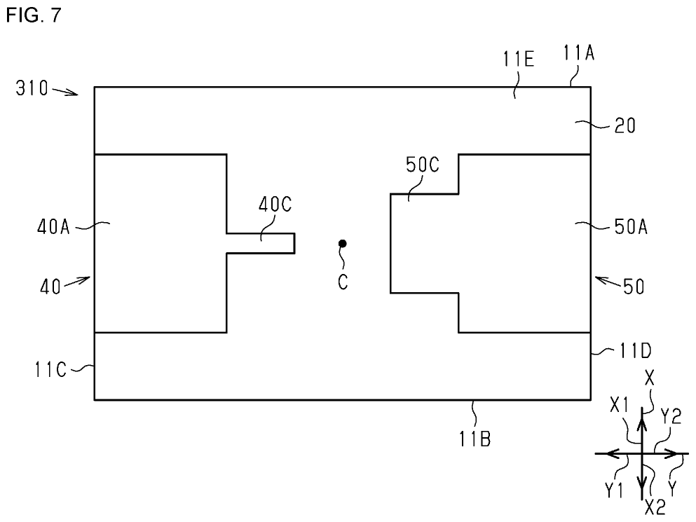

For example, in the inductor component 310 of a modification illustrated in FIG. 7, the number of the first protrusion portions 40C, the number of the second protrusion portions 50C, and the maximum dimension of the second protrusion portion 50C in the direction along the first axis X axis are different from those of the inductor component 10 of the above embodiment. Specifically, the first electrode 40 has one first protrusion portion 40C. The first protrusion portion 40C is present only in the fifth layer L5. On the other hand, the second electrode 50 has one second protrusion portion 50C. The second protrusion portion 50C is present across the third layer L3 to the seventh layer L7. That is, the maximum dimension of the second protrusion portion 50C in the direction along the first axis X is larger than the maximum dimension of the first protrusion portion 40C in the direction along the first axis X. As described above, the maximum dimension of the second protrusion portion 50C in the direction along the first axis X is different from the maximum dimension of the second protrusion portion 50C in the direction along the first axis X. Therefore, when the bottom surface 11E is viewed in the third positive direction Z1, the shape in which the first electrode 40 is exposed on the bottom surface 11E is not a two-fold rotational symmetry shape centered on the geometric center C of the bottom surface 11E with respect to the shape in which the second electrode 50 is exposed on the bottom surface 11E. As a result, when the shape and the dimension of the first bottom surface electrode portion 40A are the same as the shape and the dimension of the second bottom surface electrode portion 50A, the first electrode 40 and the second electrode 50 can be distinguished from each other because the dimension of the protrusion portion in the direction along the first axis X, that is, the width of the protrusion portion is different.

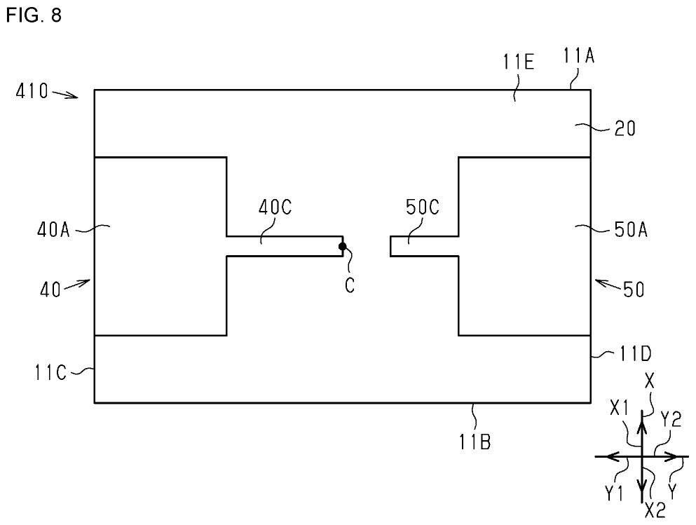

For example, in an inductor component 410 of a modification illustrated in FIG. 8, the dimension of the first protrusion portion 40C in the direction along the second axis Y and the dimension of the second protrusion portion 50C in the direction along the first axis X are different from those of the inductor component 310 of the modification illustrated in FIG. 7. Specifically, the end of the first protrusion portion 40C on the second negative direction Y2 side is located at the center of the bottom surface 11E in the direction along the second axis Y. On the other hand, the second protrusion portion 50C is present only in the fifth layer L5. The end of the second protrusion portion 50C on the second positive direction Y1 side is located on the second negative direction Y2 side from the center of the bottom surface 11E in the direction along the second axis Y. That is, the maximum dimension of the first protrusion portion 40C in the direction along the second axis Y is smaller than the maximum dimension of the second protrusion portion 50C in the direction along the second axis Y. As described above, the maximum dimension of the first protrusion portion 40C in the direction along the first axis X is different from the maximum dimension of the second protrusion portion 50C in the direction along the first axis X. Therefore, when the bottom surface 11E is viewed in the third positive direction Z1, the shape in which the first electrode 40 is exposed on the bottom surface 11E is not a two-fold rotational symmetry shape centered on the geometric center C of the bottom surface 11E with respect to the shape in which the second electrode 50 is exposed on the bottom surface 11E. As a result, when the shape and the dimension of the first bottom surface electrode portion 40A are the same as the shape and the dimension of the second bottom surface electrode portion 50A, the first electrode 40 and the second electrode 50 can be distinguished from each other because the dimension of the protrusion portion in the direction along the second axis Y, that is, the length of the protrusion portion is different.

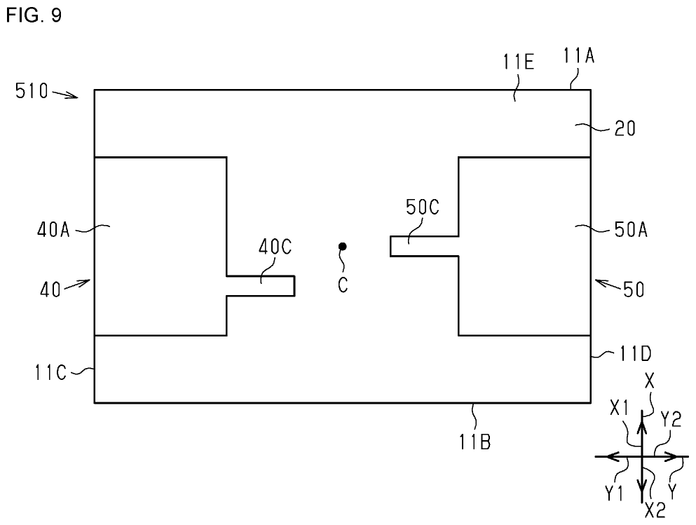

In addition, for example, in an inductor component 510 of a modification illustrated in FIG. 9, the dimension of the first protrusion portion 40C in the direction along the second axis Y and the position where the first protrusion portion 40C is present are different from those of the inductor component 410 of the modification illustrated in FIG. 8. Specifically, the maximum dimension of the first protrusion portion 40C in the direction along the second axis Y is equal to the maximum dimension of the second protrusion portion 50C in the direction along the second axis Y. The first protrusion portion 40C is present in the third layer L3. On the other hand, the second protrusion portion 50C is present in the fifth layer L5. That is, in the direction along the first axis X, the range in which the first protrusion portion 40C is present is different from the range in which the second protrusion portion 50C is present. Therefore, when the bottom surface 11E is viewed in the third positive direction Z1, the shape in which the first electrode 40 is exposed on the bottom surface 11E is not a two-fold rotational symmetry shape centered on the geometric center C of the bottom surface 11E with respect to the shape in which the second electrode 50 is exposed on the bottom surface 11E. As a result, if the shape and the dimension of the first bottom surface electrode portion 40A are the same as the shape and the dimension of the second bottom surface electrode portion 50A, the first electrode 40 and the second electrode 50 can be distinguished from each other because the position of the protrusion portion in the direction along the first axis X is different.

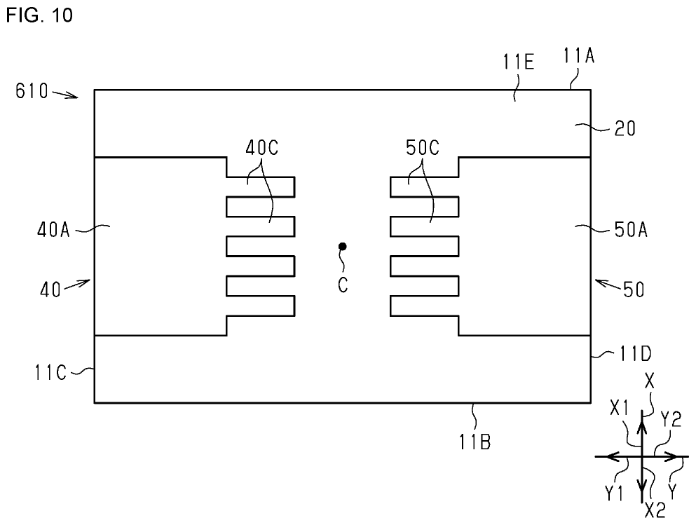

In the direction along the first axis X, the range in which the first protrusion portion 40C is present is not limited to the range in which each wiring portion is present. For example, in an inductor component 610 of a modification illustrated in FIG. 10, the number and positions of the first protrusion portions 40C are different from those of the inductor component 10 of the above embodiment. In the inductor component 610, the number and positions of the second protrusion portions 50C are different from those of the inductor component 10 of the above embodiment. Specifically, the first electrode 40 has four first protrusion portions 40C. The first protrusion portion 40C is present in each of the second layer L2, the fourth layer L4, the sixth layer L6, and the eighth layer L8 illustrated in FIG. 2. The second electrode 50 has four second protrusion portions 50C. The second protrusion portion 50C is present in each of the second layer L2, the fourth layer L4, the sixth layer L6, and the eighth layer L8 illustrated in FIG. 2. That is, the first protrusion portion 40C and the second protrusion portion 50C are present only in the layer where the via 32, the via 34, the via 36, or the via 38 is present in the inductor wiring 30 in the direction perpendicular to the first main surface 11A. Therefore, the first protrusion portion 40C and the second protrusion portion 50C do not are present in the layer where each wiring portion of the inductor wiring 30 is present in the direction along the first axis X. As described above, by shifting the positions of the wiring portions and the protrusion portions in the direction along the first axis X, it is possible to further suppress an increase in stray capacitance between them.

In the first electrode 40, the first end surface electrode portion 40B may be omitted. The first electrode 40 may have at least the first bottom surface electrode portion 40A and the first protrusion portion 40C. In addition, the end of the first bottom surface electrode portion 40A on the first end surface 11C side does not necessarily coincide with the end of the bottom surface 11E on the first end surface 11C side.

The second protrusion portions 50C may be omitted. For example, in the inductor component 10 of the above embodiment, the second protrusion portions 50C may be omitted. In this case, when the bottom surface 11E is viewed in the third positive direction Z1, the shape in which the first electrode 40 is exposed on the bottom surface 11E is not a two-fold rotational symmetry shape centered on the geometric center C of the bottom surface 11E with respect to the shape in which the second electrode 50 is exposed on the bottom surface 11E. As a result, if the shape and the dimension of the first bottom surface electrode portion 40A are the same as the shape and the dimension of the second bottom surface electrode portion 50A, the first electrode 40 and the second electrode 50 can be distinguished from each other depending on the presence or absence of the protrusion portion.

The second gap G2 may be larger than or equal to the dimension of the wiring range AW in the direction along the second axis Y. For example, in the inductor component 10 of the above embodiment, the second protrusion portions 50C may be omitted, and the dimension of the second bottom surface electrode portion 50A in the direction along the second axis Y may be reduced accordingly. In this case, the second gap G2 is a dimension of an interval between an end of the first protrusion portion 40C on the second negative direction Y2 side in the bottom surface 11E and the second bottom surface electrode portion 50A. In this case, the second gap G2 can be larger than or equal to the dimension of the wiring range AW in the direction along the second axis Y.

The shape and the dimension of the first bottom surface electrode portion 40A are not limited to the example of the above embodiment. The first bottom surface electrode portion 40A may be located only within the range from the first end surface 11C to the end on the second positive direction Y1 side in the wiring range AW in the direction along the second axis Y.

When the inductor wiring 30 is viewed in the third negative direction Z2, the inductor wiring 30 may have the circling path CR. That is, the central axis of the circling path CR may extend in the direction along the third axis Z. Even in this case, the inductor wiring 30 may have at least the lower side portion P2. In this case, the lower side portion P2 is a portion including a portion closest to the bottom surface 11E of the inductor wiring 30 and extending in parallel to the bottom surface 11E.

The circling path CR is not limited to one lap, and may be more than one lap. In this case, the upper side portion P1, the lower side portion P2, the first side portion P3, the second side portion P4, the first oblique side portion P5, and the second oblique side portion P6 correspond to portions in the outermost path of the circling path CR.

The circling path CR may have a substantially quadrangular shape when viewed in the first negative direction X2. That is, the inductor wiring 30 may not have the first oblique side portion P5 and the second oblique side portion P6.

The inductor wiring 30 may not have the circling path CR. The inductor wiring 30 may have at least the lower side portion P2. For example, the inductor wiring 30 may not have the upper side portion P1 by not being wound one turn as a whole. In this case, if a portion including a portion closer to the bottom surface 11E of the inductor wiring 30 extends parallel to the bottom surface 11E, the portion has the lower side portion P2.

The upper side portion P1 may not extend parallel to the second axis Y. The upper side portion P1 only needs to extend along the second axis Y, and the upper side portion P1 may be slightly inclined with respect to the second axis Y, or the upper side portion P1 may include a curve. Similarly to the upper side portion P1, the lower side portion P2 may not extend parallel to the second axis Y. The lower side portion P2 only needs to extend along the second axis Y, and the upper side portion P1 may be slightly inclined with respect to the second axis Y, or the lower side portion P2 may not include a curve. Further, the first side portion P3 may not extend parallel to the third axis Z. The first side portion P3 only needs to extend along the third axis Z, and the first side portion P3 may be slightly inclined with respect to the third axis Z, or the first side portion P3 may include a curve. Similarly to the first side portion P3, the second side portion P4 may not extend parallel to the third axis Z. The second side portion P4 only needs to extend along the third axis Z, and the second side portion P4 may be slightly inclined with respect to the third axis Z, or the second side portion P4 may include a curve.

The first oblique side portion P5 may not be linear. The first oblique side portion P5 may include some curves. Similarly to the first oblique side portion P5, the second oblique side portion P6 may not be linear. The second oblique side portion P6 may include some curves.

The configuration of the inductor wiring 30 is not limited to the example of the above embodiment. As long as at least the lower side portion P2 is provided, for example, only a plurality of wiring portions may be included. That is, the vias may be omitted.

The technical idea that can be grasped from the above embodiment and modifications will be described.

<1> An inductor component including an element body having a rectangular parallelepiped shape having six outer surfaces; and an inductor wiring extending inside the element body. The element body includes a first electrode connected to a first end of the inductor wiring and a second electrode connected to a second end of the inductor wiring. When a specific one surface of six outer surfaces of the element body is defined as a main surface, one of surfaces perpendicular to the main surface is defined as a first end surface, a surface parallel to the first end surface is defined as a second end surface, and one of surfaces perpendicular to both the main surface and the first end surface is defined as a bottom surface, the inductor wiring includes a lower side portion including a portion closest to the bottom surface and extending along the bottom surface. Also, when a virtual plane including an end of the lower side portion on a first end surface side and parallel to the first end surface is defined as a first virtual plane, a virtual plane including an end of the lower side portion on a second end surface side and parallel to the first end surface is defined as a second virtual plane, and a range from the first virtual plane to the second virtual plane in the element body is defined as a wiring range. The first electrode has a bottom surface electrode portion exposed to an outside of the element body on the bottom surface and a protrusion portion exposed to the outside of the element body on the bottom surface. The bottom surface electrode portion is located only within a range from the first end surface to an end on the first end surface side in the wiring range. The protrusion portion protrudes from an end of the bottom surface electrode portion on the second end surface side toward the second end surface side. A maximum dimension of the protrusion portion in a direction perpendicular to the main surface is smaller than a maximum dimension of the bottom surface electrode portion in the direction perpendicular to the main surface, and at least a part of the protrusion portion on the bottom surface is located within the wiring range.

<2> The inductor component according to <1>, in which an end of the bottom surface electrode portion on the first end surface side in the bottom surface coincides with an end of the bottom surface on the first end surface side, and a maximum dimension from the first end surface to an end of the protrusion portion on the second end surface side in a direction perpendicular to the first end surface is ¼ times or more and less than ½ times (i.e., from ¼ times to less than ½ times) a maximum dimension of the bottom surface in the direction perpendicular to the first end surface.

<3> The inductor component according to <1> or <2>, in which the inductor wiring includes a first end wiring portion extending parallel to the main surface from the first end and a second end wiring portion extending parallel to the main surface from the second end, the second end wiring portion is not present in a same layer as the first end wiring portion, and the protrusion portion is not present in a range in the element body overlapping the second end wiring portion in a direction parallel to the main surface.

<4> The inductor component according to any one of <1> to <3>, in which the bottom surface electrode portion has a quadrangular shape on the bottom surface. When an interval between an end of the bottom surface electrode portion on the second end surface side and an end of the second electrode on the first end surface side on the bottom surface in a direction perpendicular to the first end surface is defined as a first gap, the first gap is larger than a maximum dimension of the lower side portion in the direction perpendicular to the first end surface. Also, when an interval between an end of the protrusion portion on the second end surface side and an end of the second electrode on the first end surface side on the bottom surface in the direction perpendicular to the first end surface is defined as a second gap, the second gap is smaller than the maximum dimension of the lower side portion in the direction perpendicular to the first end surface.

<5> The inductor component according to any one of <1> to <4>, in which the inductor wiring includes a plurality of wiring portions extending in parallel to the main surface, and a via connecting the plurality of wiring portions in the direction perpendicular to the main surface. The plurality of wiring portions include a circling path that circles when viewed in the direction perpendicular to the main surface, and a maximum dimension of the lower side portion in a direction perpendicular to the first end surface is smaller than a maximum dimension of the circling path in the direction perpendicular to the first end surface.

<6> The inductor component according to any one of <1> to <5>, in which the inductor wiring includes a plurality of wiring portions extending in parallel to the main surface and a via connecting the plurality of wiring portions in the direction perpendicular to the main surface. The plurality of wiring portions include a circling path that circles when viewed in the direction perpendicular to the main surface, and the protrusion portion is present only in a range in the element body overlapping the wiring portion in a direction parallel to the main surface.

<7> The inductor component according to any one of <1> to <5>, in which the inductor wiring includes a plurality of wiring portions extending in parallel to the main surface and a via connecting the plurality of wiring portions in the direction perpendicular to the main surface. The plurality of wiring portions include a circling path that circles when viewed in the direction perpendicular to the main surface, and the protrusion portion is present only in a range of the element body overlapping the via in a direction parallel to the main surface.

<8> The inductor component according to any one of <1> to <7>, in which when viewed in a direction perpendicular to the bottom surface, a shape in which the first electrode is exposed on the bottom surface is not a two-fold rotational symmetry shape centered on a geometric center of the bottom surface with respect to a shape in which the second electrode is exposed on the bottom surface.

<9> The inductor component according to any one of <1> to <8>, in which when the bottom surface electrode portion is a first bottom surface electrode portion, and the protrusion portion is a first protrusion portion, the second electrode has a second bottom surface electrode portion exposed to an outside of the element body on the bottom surface and a second protrusion portion exposed to the outside of the element body on the bottom surface, the second bottom surface electrode portion is located only within a range from the second end surface to an end on the second end surface side in the wiring range, the second protrusion portion protrudes toward the first end surface side from an end of the second bottom surface electrode portion on the first end surface side, a maximum dimension of the second protrusion portion in the direction perpendicular to the main surface is smaller than a maximum dimension of the second bottom surface electrode portion in the direction perpendicular to the main surface, and at least a part of the second protrusion portion on the bottom surface is located within the wiring range.

<10> The inductor component according to <9>, in which a shape and a dimension of the first bottom surface electrode portion are same as a shape and a dimension of the second bottom surface electrode portion, and a maximum dimension of the first protrusion portion in the direction perpendicular to the main surface is different from a maximum dimension of the second protrusion portion in the direction perpendicular to the main surface.

<11> The inductor component according to <9> or <10>, in which a shape and a dimension of the first bottom surface electrode portion are same as a shape and a dimension of the second bottom surface electrode portion, and a maximum dimension of the first protrusion portion in a direction perpendicular to the first end surface is different from a maximum dimension of the second protrusion portion in the direction perpendicular to the first end surface.

<12> The inductor component according to any one of <9> to <11>, in which a shape and a dimension of the first bottom surface electrode portion are same as a shape and a dimension of the second bottom surface electrode portion, and a number of the first protrusion portion is different from a number of the second protrusion portion.

<13> The inductor component according to any one of <9> to <12>, in which the first protrusion portion is not located in a range in the element body overlapping the second protrusion portion in a direction parallel to the main surface.

<14> The inductor component according to any one of <1> to <13>, further including a first covering electrode covering the first electrode.

<15> The inductor component according to any one of <1> to <14>, in which the inductor wiring includes a plurality of wiring portions extending in parallel to the main surface, and a via connecting the plurality of wiring portions in the direction perpendicular to the main surface, and each of the plurality of wiring portions includes a side portion extending along the first end surface, and an oblique side portion connecting the lower side portion and the side portion in an oblique direction.

<16> The inductor component according to any one of <1> to <15>, in which the inductor wiring includes a plurality of wiring portions extending in parallel to the main surface, and a via connecting the plurality of wiring portions in the direction perpendicular to the main surface. When a surface parallel to the bottom surface among the six outer surfaces of the element body is defined as a top surface, each of the plurality of wiring portions includes an upper side portion extending along the top surface, and the upper side portion is located on a top surface side with respect to the lower side portion.

<17> The inductor component according to any one of <1> to <16>, in which the inductor wiring includes a plurality of wiring portions extending in parallel to the main surface, and a via connecting the plurality of wiring portions in the direction perpendicular to the main surface. The plurality of wiring portions include a circling path that circles when viewed in the direction perpendicular to the main surface. When a surface parallel to the bottom surface among the six outer surfaces of the element body is defined as a top surface, each of the plurality of wiring portions includes a first side portion extending along the first end surface, a first oblique side portion connecting the lower side portion and the first side portion in an oblique direction, an upper side portion extending along the top surface, a second side portion extending along the second end surface, and a second oblique side portion connecting the lower side portion and the second side portion in an oblique direction, the upper side portion is located on a top surface side with respect to the lower side portion, the second side portion is located on the second end surface side with respect to the first side portion, the second oblique side portion is located on the second end surface side with respect to the first oblique side portion, and the circling path includes the lower side portion, the first oblique side portion, the first side portion, the upper side portion, the second side portion, and the second oblique side portion.

What is claimed is:

1. An inductor component comprising:
an element body having a rectangular parallelepiped shape having six outer surfaces; and
an inductor wiring extending inside the element body,
wherein
the element body includes a first electrode connected to a first end of the inductor wiring and a second electrode connected to a second end of the inductor wiring,
when a specific one surface of six outer surfaces of the element body is defined as a main surface, one of surfaces perpendicular to the main surface is defined as a first end surface, a surface parallel to the first end surface is defined as a second end surface, and one of surfaces perpendicular to both the main surface and the first end surface is defined as a bottom surface,
the inductor wiring includes a lower side portion including a portion closest to the bottom surface and extending along the bottom surface, and
when a first virtual plane is defined as a virtual plane including an end of the lower side portion on a first end surface side and being parallel to the first end surface,
a second virtual plane is defined as a virtual plane including an end of the lower side portion on a second end surface side and being parallel to the first end surface,
and a wiring range is defined as a range from the first virtual plane to the second virtual plane in the element body,
the first electrode has a bottom surface electrode portion exposed to an outside of the element body on the bottom surface and a protrusion portion exposed to the outside of the element body on the bottom surface,
the bottom surface electrode portion is only within a range from the first end surface to an end of the wiring range on the first end surface side,
the protrusion portion protrudes from an end of the bottom surface electrode portion on the second end surface side toward the second end surface side,
a maximum dimension of the protrusion portion in a direction perpendicular to the main surface is smaller than a maximum dimension of the bottom surface electrode portion in the direction perpendicular to the main surface, and
at least a part of the protrusion portion on the bottom surface is within the wiring range.

2. The inductor component according to claim 1, wherein
on the bottom surface, an end of the bottom surface electrode portion on the first end surface side coincides with an end of the bottom surface on the first end surface side, and
a maximum dimension from the first end surface to an end of the protrusion portion on the second end surface side in a direction perpendicular to the first end surface is from ¼ times to less than ½ times a maximum dimension of the bottom surface in the direction perpendicular to the first end surface.

3. The inductor component according to claim 1, wherein
the inductor wiring includes a first end wiring portion extending parallel to the main surface from the first end and a second end wiring portion extending parallel to the main surface from the second end,
the second end wiring portion is absent from a same layer as the first end wiring portion in the direction perpendicular to the main surface, and
the protrusion portion is absent from a same layer as the second end wiring portion in the direction perpendicular to the main surface.

4. The inductor component according to claim 1, wherein
when the bottom surface electrode portion is a first bottom surface electrode portion, and the protrusion portion is a first protrusion portion,
the second electrode has a second bottom surface electrode portion exposed to an outside of the element body on the bottom surface and a second protrusion portion exposed to the outside of the element body on the bottom surface,
the first bottom surface electrode portion and the second bottom surface electrode have a quadrangular shape on the bottom surface,
when a first gap is defined as an interval between an end of the first bottom surface electrode portion on the second end surface side and an end of the second bottom surface electrode portion on the first end surface side in a direction perpendicular to the first end surface, the first gap is larger than a maximum dimension of the lower side portion in the direction perpendicular to the first end surface, and
when a second gap is defined as an interval between an end of the first protrusion portion on the second end surface side and an end of the second protrusion portion on the first end surface side in the direction perpendicular to the first end surface, the second gap is smaller than the maximum dimension of the lower side portion in the direction perpendicular to the first end surface.

5. The inductor component according to claim 1, wherein
the inductor wiring includes a plurality of wiring portions extending in parallel to the main surface and arranged in the direction perpendicular to the main surface, and a via connecting the plurality of wiring portions in the direction perpendicular to the main surface,
the plurality of wiring portions includes a circling path when viewed in the direction perpendicular to the main surface, and
a maximum dimension of the lower side portion in a direction perpendicular to the first end surface is smaller than a maximum dimension of the circling path in the direction perpendicular to the first end surface.

6. The inductor component according to claim 1, wherein
the inductor wiring includes a plurality of wiring portions extending in parallel to the main surface and arranged in the direction perpendicular to the main surface, and a via connecting the plurality of wiring portions in the direction perpendicular to the main surface,
the plurality of wiring portions includes a circling path when viewed in the direction perpendicular to the main surface, and
the protrusion portion is present only in a layer where the wiring portion is present in the direction perpendicular to the main surface.

7. The inductor component according to claim 1, wherein
the inductor wiring includes a plurality of wiring portions extending in parallel to the main surface, and a via connecting the plurality of wiring portions in the direction perpendicular to the main surface,
the plurality of wiring portions includes a circling path when viewed in the direction perpendicular to the main surface, and
the protrusion portion is present only in a layer where the via is present in the direction perpendicular to the main surface.

8. The inductor component according to claim 1, wherein
when viewed in a direction perpendicular to the bottom surface, an exposed shape of the first electrode on the bottom surface is not a two-fold rotational symmetry with respect to an exposed shape of the second electrode on the bottom surface about a geometric center of the bottom surface.

9. The inductor component according to claim 1, wherein
when the bottom surface electrode portion is a first bottom surface electrode portion, and the protrusion portion is a first protrusion portion,
the second electrode has a second bottom surface electrode portion exposed to an outside of the element body on the bottom surface and a second protrusion portion exposed to the outside of the element body on the bottom surface,
the second bottom surface electrode portion is only within a range from the second end surface to an end of the wiring range on the second end surface side,
the second protrusion portion protrudes from an end of the second bottom surface electrode portion on the first end surface side toward the first end surface side,
a maximum dimension of the second protrusion portion in the direction perpendicular to the main surface is smaller than a maximum dimension of the second bottom surface electrode portion in the direction perpendicular to the main surface, and
at least a part of the second protrusion portion on the bottom surface is within the wiring range.

10. The inductor component according to claim 9, wherein
a shape and a dimension of the first bottom surface electrode portion are same as a shape and a dimension of the second bottom surface electrode portion, and
a maximum dimension of the first protrusion portion in the direction perpendicular to the main surface is different from a maximum dimension of the second protrusion portion in the direction perpendicular to the main surface.

11. The inductor component according to claim 9, wherein
a shape and a dimension of the first bottom surface electrode portion are same as a shape and a dimension of the second bottom surface electrode portion, and
a maximum dimension of the first protrusion portion in a direction perpendicular to the first end surface is different from a maximum dimension of the second protrusion portion in the direction perpendicular to the first end surface.

12. The inductor component according to claim 9, wherein
a shape and a dimension of the first bottom surface electrode portion are same as a shape and a dimension of the second bottom surface electrode portion, and
a number of the first protrusion portion is different from a number of the second protrusion portion.

13. The inductor component according to claim 9, wherein
the first protrusion portion is absent from a layer where the second protrusion portion is present in the direction perpendicular to the main surface.

14. The inductor component according to claim 1, further comprising:
a first covering electrode covering the first electrode.

15. The inductor component according to claim 1, wherein
the inductor wiring includes a plurality of wiring portions extending in parallel to the main surface and arranged in the direction perpendicular to the main surface, and a via connecting the plurality of wiring portions in the direction perpendicular to the main surface, and
the plurality of wiring portions includes a side portion extending along the first end surface, and an oblique side portion connecting the lower side portion and the side portion in an oblique direction.

16. The inductor component according to claim 1, wherein
the inductor wiring includes a plurality of wiring portions extending in parallel to the main surface and arranged in the direction perpendicular to the main surface, and a via connecting the plurality of wiring portions in the direction perpendicular to the main surface,
when a surface parallel to the bottom surface among the six outer surfaces of the element body is defined as a top surface,
the plurality of wiring portions includes an upper side portion extending along the top surface, and
the upper side portion is on a top surface side with respect to the lower side portion.

17. The inductor component according to claim 1, wherein
the inductor wiring includes a plurality of wiring portions extending in parallel to the main surface and arranged in the direction perpendicular to the main surface, and a via connecting the plurality of wiring portions in the direction perpendicular to the main surface,
the plurality of wiring portions includes a circling path when viewed in the direction perpendicular to the main surface, and
when a surface parallel to the bottom surface among the six outer surfaces of the element body is defined as a top surface,
the plurality of wiring portions includes a first side portion extending along the first end surface, a first oblique side portion connecting the lower side portion and the first side portion in an oblique direction, an upper side portion extending along the top surface, a second side portion extending along the second end surface, and a second oblique side portion connecting the lower side portion and the second side portion in an oblique direction,
the upper side portion is on a top surface side with respect to the lower side portion,
the second side portion is on the second end surface side with respect to the first side portion,
the second oblique side portion is on the second end surface side with respect to the first oblique side portion, and
the circling path includes the first side portion, the first oblique side portion, the lower side portion, the second oblique side portion, the second side portion, and the upper side portion.
